(19) United States
(12) Patent Application Publication
(10) Pub. No.: US 2011/0225319 A1
(43) Pub. Date: Sep. 15, 2011

(54) ROUTE OPTIMIZATION METHOD, ROUTE OPTIMIZATION SYSTEM, MOBILE COMMUNICATION DEVICE, MOVEMENT MANAGEMENT DEVICE, PARTNER COMMUNICATION DEVICE AND HOME BASE STATION

(75) Inventors: Keigo Aso, Kanagawa (JP); Shinkichi Ikeda, Kanagawa (JP)

(73) Assignee: PANASONIC CORPORATION, Osaka (JP)

(21) Appl. No.: 13/125,355

(22) PCT Filed: Dec. 7, 2009
(86) PCT No.: PCT/JP2009/006656

§ 371 Date: Apr. 21, 2011

(30) Foreign Application Priority Data
Dec. 8, 2008 (JP) 2008-312301

(51) Int. Cl. G06F 15/173

(52) U.S. Cl. 709/238

(57) ABSTRACT

Disclosed is a technique to allow a network operator of a mobile node to securely reject an unfavorable address for use in route optimization. According to the technique, when receiving a HoTI message 40 (Step S1), a HA 30 checks whether a sender address CoA of an external IP header 41 is a registered CoA or not (Step S2), and when it is not a registered CoA, the HA 30 discards the HoTI message 40 (Step S3). When it is a registered CoA, the HA 30 checks whether CoA1 in a CoA option 46 is OK for route optimization or not (Step S4). When it is OK for route optimization, the HA 30 transfers a decapsulated HoTI message 42 to a CN 20 (Step S5). On the other hand, when it is not OK for route optimization, the HA 30 discards the HoTI message 40 (Step S3).

### TECHNICAL FIELD

The present invention relates to a route optimization method and a route optimization system for communication between a mobile node (communication device) and a correspondent node (partner communication device) with a direct path not via a mobility (movement) management device on the mobile node.

The present invention further relates to the mobile node, the mobility management device and the correspondent node.

The present invention still further relates to a home base station.

### BACKGROUND ART

A mobile node (hereinafter called a MN) using a mobile IP (the following Non-Patent Document 1) registers a care-of address (hereinafter called CoA) as a destination address with a home agent (hereinafter called a HA) that is a mobility management node managing a home address (HoA) of the mobile node or with a correspondent node (hereinafter called a CN), and requests to transfer a packet addressed to the HoA. In the case of a MN with a plurality of interfaces, such a MN may associate a plurality of CoAs with one HoA at the same time for registration, whereby the MN can perform prompt switching of the CoAs used depending on the interfaces by registering a CoA allocated to each interface. The following Non-Patent Document 2 describes a technique for a MN of associating a plurality of CoAs with one HoA for registration.

To further allow a MN to register a binding cache (hereinafter called a BC) with a CN and to use route optimization (RO), the MN has to execute return routability (hereinafter called RR) beforehand to share a key with the CN. The MN uses a key acquired through the RR to generate authentication information (Message Authentication Code: MAC), and adds the MAC to a binding update (BU) message and transmits the resultant to the CN. The CN can verify the authentication information added to the received BU message so as to check whether the BU message is transmitted from a correct MN or not that shares the HoA and the CoA included in the BU message, thus preventing unauthorized action that registers another node's address as the CoA.

The following describes the RR in the case where a MN has a plurality of CoAs. A MN may have a plurality of CoAs, for example, in the case where a plurality of CoAs are allocated to an interface connected to a foreign network and in the case where the MN has a plurality of interfaces connected to a foreign network. Since RR is performed for a HoA and a CoA that the MN registers with a CN, when a plurality of CoAs is to be registered for a HoA, RR is executed for each of the CoAs. For instance, even when the MN has a plurality of CoAs, if a notice on a specific CoA among the plurality of CoAs is given to the CN for route optimization, RR simply may be executed to the CoA only and a BU message is transmitted thereto.

A plurality of CoAs that a MN has may include a CoA that a network operator of the MN may use for route optimization and a CoA that is not favorable for such a use. In this case, the operator controls the RR executed by the MN depending on a CoA, whereby the operator can reject route optimization for an unfavorable CoA and can permit route optimization for a favorable CoA.

The following Patent Document 1 discloses a method of blocking RR that a MN executes depending on a CoA. According to this method, a HA checks a sender address (a sender address of an encapsulated HoTI message) set in an external header of a HoTI (Home Test Init) message that the HA receives from a MN, and if the address is permitted for route optimization, the HA transfers the HoTI message as an internal packet to a CN, and if the address is not permitted for route optimization, such a message is not transferred (discarded), thus controlling whether or not to perform RR depending on a CoA. For instance, consider the case where a MN has two CoAs of CoA1 and CoA2, and an operator permits route optimization for CoA1 but does not permit route optimization for CoA2. When the MN transmits a HoTI message and a CoTI (Care of Test Init) message using CoA1 to execute RR for CoA1, the HA confirms that a sender address of an external header in the received HoTI message is CoA1, and transfers a decapsulated HoTI message to the CN.

Meanwhile, when the MN transmits a HoTI message and a CoTI message using CoA2 to execute RR for CoA2, the HA confirms that a sender address of an external header in the received encapsulated HoTI message is CoA2, and the HA does not transfer an internal HoTI message to the CN. Thereby, RR for CoA1 is performed successfully so that the MN can register a BC with the CN. On the other hand, RR for CoA2 fails, so that the MN cannot register a BC with the CN.

### PRIOR ART DOCUMENT

### Patent Document

Patent Document 1: PCT Japan phase Application Publication No. 2007-533279 (FIG. 10, paragraphs 0074 to 0080)

### Non-Patent Document

Non-Patent Document 1: D. Johnson, C. Perkins, J. Arkko, “Mobility Support in IPv6”, RFC3775, June 2004

Non-Patent Document 2: R. Wakikawa, T. Ernst, K. Nagami, V. Devarapalli “Multiple Care-of Addresses Registration”, draft-ietf-monami6-multiplecoa-05.txt, January 2008

According to the method described in Patent Document 1, however, when a (malicious) MN transmits a CoTI message having CoA2 as a sender address to execute route optimization for CoA2 while transmitting a HoTI message having CoA1 as a sender address, such a method allows the malicious MN to perform RR successfully to register a BC. This is because the HoTI message transmitted from CoA1 is encapsulated using CoA1 and is transferred to the HA and the HA transfers the HoTI message as an internal packet thereof, and therefore the HoTI message is delivered to a CN. Since the HoTI message received by the CN is a packet with a sender address thereof set as HoA, the CN does not care whether the HoTI message is transmitted from CoA1 or from CoA2. As a result, the CN returns a HoT (Home Test) message in response to the HoTI message, and further returns a CoT (Care of Test) message in response to the CoTI message as well. Thus, RR for CoA2 is performed successfully so that the MN successfully transmits a BU message for registration of CoA2. This means that with the conventional method a network operator will fail to control RR depending on CoAs of the MN.

### SUMMARY OF THE INVENTION

In view of the above-stated problems, it is an object of the present invention to provide a route optimization method, a route optimization system, a mobile node, a mobility management device, a correspondent node and a home base station, by which a network operator of the mobile node can securely reject an unfavorable address for use in route optimization.

In order to fulfill the above-stated object, a route optimization method for communication between a mobile node and a correspondent node with a direct path not via a mobility management device of the mobile node, includes the steps of: a step where the mobile node generates a route optimization request message addressed to the correspondent node and containing a desired address for use with the direct path, and encapsulates the generated route optimization request message addressed to the mobility management device for transmission; and a step where the mobility management device checks whether the address in the route optimization request message is an address permitted for route optimization or not, and when the address in the route optimization request message is an address permitted, the mobility management device transfers the route optimization request message to the correspondent node, and when the address in the route optimization request message is not an address permitted, the mobility management device discards the route optimization request message.

In order to fulfill the above-stated object, in a route optimization system for communication between a mobile node and a correspondent node with a direct path not via a mobility management device of the mobile node, the mobile node includes a unit that generates a route optimization request message addressed to the correspondent node and containing a desired address for use with the direct path and encapsulates the generated route optimization request message addressed to the mobility management device for transmission, and the mobility management device includes a unit that checks whether the address in the route optimization request message is an address permitted for route optimization or not, and when the address in the route optimization request message is an address permitted, transfers the route optimization request message to the correspondent node, and when the address in the route optimization request message is not an address permitted, discards the route optimization request message.

In order to fulfill the above-stated object, a mobile node in a route optimization system for communication between the mobile node and a correspondent node with a direct path not via a mobility management device of the mobile node, includes a unit that generates a route optimization request message addressed to the correspondent node and containing a desired address for use with the direct path and encapsulates the generated route optimization request message addressed to the mobility management device for transmission.

In order to fulfill the above-stated object, a mobility management device in a route optimization system for communication between a mobile node and a correspondent node with a direct path not via the mobility management device of the mobile node, includes: a unit that receives a message obtained by encapsulating a route optimization request message addressed to the mobility management device, the route optimization request message being addressed to the correspondent node and containing a desired address for use with the direct path; and a unit that checks whether the address in the route optimization request message is an address permitted for route optimization or not, and when the address in the route optimization request message is an address permitted, transfers the route optimization request message to the correspondent node, and when the address in the route optimization request message is not an address permitted, discards the route optimization request message.

In order to fulfill the above-stated object, a correspondent node in a route optimization system for communication between a mobile node and the correspondent node with a direct path not via a mobility management device of the mobile node, includes: a unit that receives a route optimization request message addressed to the correspondent node and containing a desired address for use with the direct path and a second route optimization request message transmitted from the mobile node addressed to the correspondent node, the second route optimization request message being different from the route optimization request message; and a unit that compares a desired address for use with the direct path in the route optimization request message with a sender address of the second route optimization request message, and in the case of agreement, permits the direct path, and in the case of disagreement, does not permit the direct path.

In order to fulfill the above-stated object, a route optimization method for communication between a mobile node and a correspondent node with a direct path not via a mobility management device of the mobile node, includes the steps of: a step where the mobile node generates a route optimization request message addressed to the correspondent node and containing a desired address for use with the direct path, and transmits the generated route optimization request message addressed to a home base station; and a step where the home base station checks whether the address in the route optimization request message is an address permitted for route optimization or not, and when the address in the route optimization request message is an address permitted, the home base station transfers the route optimization request message to the correspondent node via the mobility management device, and when the address in the route optimization request message is not an address permitted, the home base station discards the route optimization request message.

In order to fulfill the above-stated object, in a route optimization system for communication between a mobile node and a correspondent node with a direct path not via a mobility management device of the mobile node, the mobile node includes a unit that generates a route optimization request message addressed to the correspondent node and containing a desired address for use with the direct path and transmits the generated route optimization request message addressed to a home base station, and the home base station includes a unit that checks whether the address in the route optimization request message is an address permitted for route optimization or not, and when the address in the route optimization request message is an address permitted, transfers the route optimization request message to the correspondent node via the mobility management device, and when the address in the route optimization request message is not an address permitted, discards the route optimization request message.

In order to fulfill the above-stated object, a mobile node in a route optimization system for communication between the mobile node and a correspondent node with a direct path not via a mobility management device of the mobile node, includes a unit that generates a route optimization request message addressed to the correspondent node and containing a desired address for use with the direct path and transmits the generated route optimization request message addressed a home base station.

In order to fulfill the above-stated object, a home base station in a route optimization system for communication between a mobile node and a correspondent node with a direct path not via a mobility management device of the mobile node, includes: a unit that receives a route optimization request message addressed to the correspondent node and containing a desired address for use with the direct path; and a unit that checks whether the address in the route optimization request message is an address permitted for route optimization or not, and when the address in the route optimization request message is an address permitted, transfers the route optimization request message to the correspondent node via the mobility management device, and when the address in the route optimization request message is not an address permitted, discards the route optimization request message.

With this configuration, a route optimization request message that a mobile node transfers to a mobility management device includes a desired address for use with a direct path, and the mobility management checks whether the address in the first route optimization request message is an address permitted for route optimization or not. Therefore a network operator of the mobile node can securely reject an unfavorable address for use in route optimization.

In order to fulfill the above-stated object, a correspondent node in a route optimization system for communication between a mobile node and the correspondent node with a direct path not via a mobility management device of the mobile node, includes: a unit that receives a route optimization request message addressed to the correspondent node and containing a desired address for use with the direct path; and a unit that transmits, to the mobile node, a response message containing message authentication code generation information generated from a sender address of the route optimization request message and a desired address for use with the direct path.

With this configuration, a response message returned from the correspondent node to the mobile node in response to the route optimization request message includes the message authentication code generation information generated from a sender address of the route optimization request message and a desired address for use with the direct path. Therefore, the mobile node cannot generate a true message authentication code based on an address not permitted for the direct path, and so an unfavorable address to be used for route optimization can be securely rejected.

According to the present invention, a network operator of the mobile node can securely reject an unfavorable address for use in route optimization.

### BRIEF DESCRIPTION OF THE DRAWINGS

FIG. 1 shows the configuration of a network in Embodiment 1 of the present invention.

FIG. 2 shows the configuration of another network in Embodiment 1 of the present invention.

FIG. 3 shows the configuration of still another network in Embodiment 1 of the present invention.

FIG. 4 is a block diagram showing the configuration of a mobile node in Embodiment 1 of the present invention.

FIG. 5 shows the configuration of a HoTI message in Embodiment 1 of the present invention.

FIG. 6 shows the configuration of a CoTI message in Embodiment 1 of the present invention.

FIG. 7 is a block diagram showing the configuration of a home agent in Embodiment 1 of the present invention.

FIG. 8 is a flowchart describing the processing by a home agent in Embodiment 1 of the present invention.

FIG. 9 is a flowchart describing a modification example of the processing in FIG. 8.

FIG. 10 is a block diagram showing the configuration of a CN in Embodiment 1 of the present invention.

FIG. 11 describes processing and a communication sequence in Embodiment 3 of the present invention.

FIG. 12 is a block diagram showing the configuration of a mobile node in Embodiment 3 of the present invention.

FIG. 13 shows the configuration of an address notification message in Embodiment 3 of the present invention.

FIG. 14 is a flowchart describing exemplary processing by a mobile node in Embodiment 3 of the present invention.

FIG. 15 is a flowchart describing another exemplary processing by a mobile node in Embodiment 3 of the present invention.

FIG. 16 is a block diagram showing the configuration of a home agent in Embodiment 3 of the present invention.

FIG. 17 shows the configuration of a network in Embodiment 4 of the present invention.

FIG. 18 describes processing and a communication sequence in Embodiment 4 of the present invention.

FIG. 19 is a block diagram showing the configuration of a home base station in Embodiment 4 of the present invention.

### DESCRIPTION OF EMBODIMENTS

The following describes embodiments of the present invention, with reference to the drawings.

### Embodiment 1

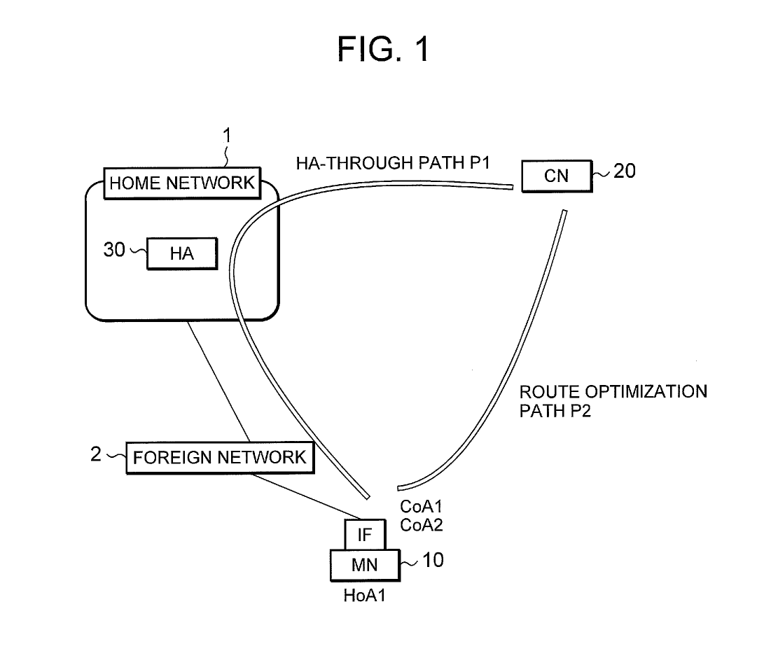

FIG. 1 shows the configuration of a network in Embodiment 1 of the present invention. In FIG. 1, a home network 1 and a foreign network 2 are provided, and a MN 10 is managed by a HA 30 of the home network 1 and has HoA1 as a home address allocated thereto. An interface IF of the MN 10 connects with the foreign network 2, to which two addresses CoA1 and CoA2 are allocated as an example of a plurality of addresses. A CN 20 as a correspondent node of the MN 10 can perform communication (HA-through path P1 or route optimization path P2) using HoA1 or CoA1 of the MN 10. A plurality of addresses may be allocated, for example, in the case where the MN 10 generates a plurality of addresses (CoA1, CoA2) from a prefix advertised in the foreign network 2, or in the case where the foreign network 2 with which the MN 10 connects advertises a plurality of prefixes and an address (CoA1, CoA2) is generated from each prefix (prefix 1, prefix 2). In this case, prefix 1 is a prefix allocated from the home network 1, and CoA1 is used for packet transmission/reception using the HA-through path P1. CoA2 is used for packet transmission/reception using the route optimization path P2 not via the HA 30.

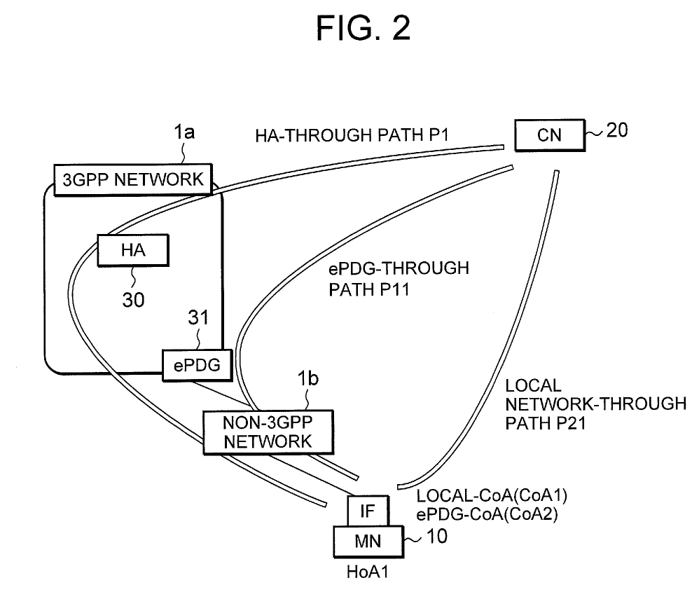

As shown in FIG. 2, when the MN 10 using a 3GPP network 1a connects with a Non-3GPP network 1b, two addresses are allocated, including an address (Local-CoA: CoA1) acquired from a local network as a connection destination and an address (ePDG-CoA: CoA2) acquired from an ePDG (evolved Packet Data Gateway) 31 as a gateway to the 3GPP network 1b. An IPSec tunnel is configured between the ePDG 31 and the MN 10, and the Local-CoA is used for a terminal address on the MN 10 side. In this case, two route optimization paths exist between the MN 10 and the CN 20, one of which is an ePDG-through path P11 and the other is a local network-through path P21 directly accessing the CN 20 from the local network. Note that the MN is called a UE (User Equipment) and the HA is called a PDN-Gateway (Packet Data Network Gateway) in terms of 3GPP networks.

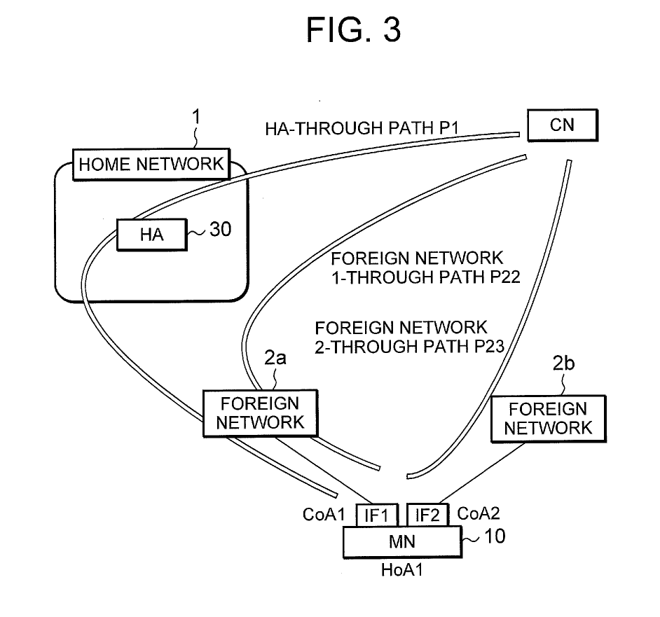

As shown in FIG. 3, in a further assumed case, the MN 10 is provided with two interfaces IF1 and IF2, to which addresses CoA1 and CoA2 are allocated, respectively. In this case, two paths exist between the MN 10 and the CN 20, including a path P22 directly accessing the CN 20 from a foreign network 2a and a path P23 directly accessing the CN 20 from a foreign network 2b. In the following description, a node performing communication with the MN 10 is called a CN meaning a correspondent node as distinguished from the MN 10. However, such a node actually is a mobile node like the MN 10 in the present invention.

The following description of Embodiment 1 of the present invention assumes that the MN 10 uses CoA1 for route optimization between the two care-of addresses (CoA1, CoA2) during communication with the CN 20. In this case, the MN 10 has to register, with the CN 20, positional information including the association of CoA1 with HoA1. To this end, the MN 10 executes RR for HoA1 and CoA1 to notify the CN 20 that the registered HoA1 and CoA1 are owned by the MN 10 itself.

### <Configuration of MN>

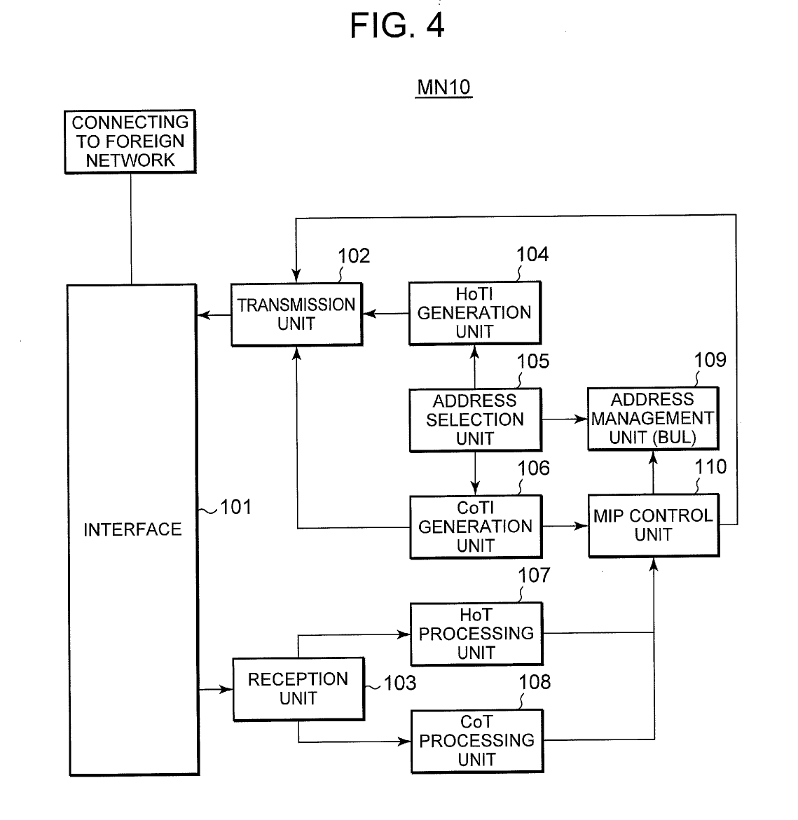

FIG. 4 shows the configuration of the MN 10 in Embodiment 1 of the present invention. The MN 10 includes an interface 101, a transmission unit 102, a reception unit 103, a HoTI (Home Test Init) generation unit 104, an address selection unit 105, a CoTI (Care of Test Init) generation unit 106, a HoT (Home Test) processing unit 107, a CoT (Care of Test) processing unit 108, an address management unit (BUL) 109, and a MIP (mobile IP) control unit 110. The transmission unit 102 has a function to transmit a packet to a node on a network connected (foreign network 2) via the interface 101. The reception unit 103 has a function to receive a packet from a node on a network connected (foreign network 2) via the interface 101.

The address management unit (BUL) 109 manages a plurality of addresses (CoA1 and CoA2) allocated to the interface 101 of the MN 10. The address selection unit 105 keeps various types of information that is considered to select an address to be used for route optimization, which will be described later. The address management unit (BUL) 109 further may function as a binding update list (BUL) that keeps association information between HoA1, CoA1 and CoA2. The address selection unit 105 selects an address (CoA1) to be used for communication using route optimization with the CN 20 from the care-of addresses (CoA1 and CoA2) kept by the address management unit 109.

Various criteria used for such a selection can be considered. For instance, the address may be selected depending on a network operator who allocates the care-of address, or the address may be selected by making a comparison with an operator to which a correspondent node belongs, a network with which a correspondent node connects, and the address of the CN 20 (whether the address belongs to the same domain as the correspondent node or not). Further, the address may be selected based on a QoS (Quality of Service) state and communication cost when these care-of addresses are used, or as shown in FIG. 2, when the MN 10 uses the 3GPP network 1a, since one of the two addresses is a Local-CoA and the other is an ePDG-CoA, the address may be selected with consideration given to the difference therebetween. For instance, when the MN 10 wants to use a path of a minimum length for communication with the CN 20, a communication path using the Local-CoA can be shortened than that using the ePDG-CoA as shown in FIG. 2, and therefore the MN 10 will select the Local-CoA. A priority has to be given to another condition other than the length of a communication path, the address will be selected based on such a condition. The MN 10 may select a CoA used for route optimization from CoAs registered with the HA 30.

Following the selection by the address selection unit 105 of a desired address (CoA1) to be used for the route optimization with the CN 20, the HoTI generation unit 104 generates a HoTI message addressed to the CN 20 including the selected address as an option, and encapsulates the HoTI message addressed to the HA 30 for transmission. The HoTI message further may include an option including the HoA or the ID of the MN 10 as information allowing the HA 30 and the CN 20 to identify the sender node of the received HoTI message. The HoTI generation unit 104 further may incorporate numerical information such as a sequence number or a cookie so as to allow the CN 20 to understand a correspondence relationship between the HoTI message and the CoTI message. The value included as the CoA option, i.e., the information that the CN 20 uses for comparison, may be not only the care-of address itself but also a hash value generated from the CoA or the HoA. In this case, the CoTI message also includes a similar hash value.

### <HoTI>

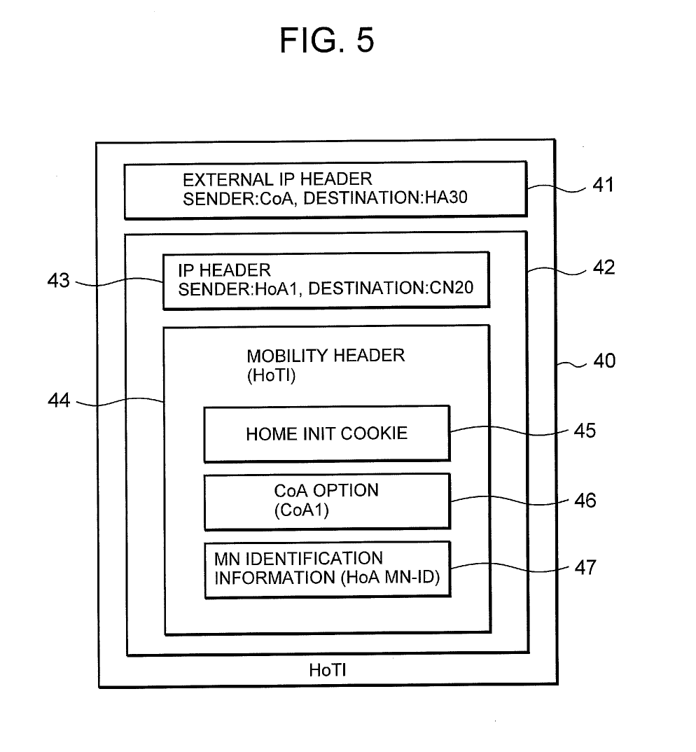

FIG. 5 shows a HoTI message 40 generated by the HoTI generation unit 104. The HoTI message 40 is a packet obtained by encapsulating a HoTI message 42 from the MN 10 to the CN 20 as an internal packet, where a sender address of an external IP header 41 is CoA and a destination address thereof is the address of the HA 30. The internal HoTI message 42 includes an IP header 43 and a mobility header 44, where the IP header 43 has HoA1 as a sender address and the address of the CN 20 as a destination address. When receiving the HoTI message 40, the HA 30 decapsulates the HoTI message 40 and transmits the HoTI message 42 addressed to the CN 20.

The mobility header 44 includes a normal cookie for home test (Home Init Cookie) 45 as well as a CoA option 46 and MN identification information 47 as options. The CoA option 46 includes a desired address (CoA1) to be used for the route optimization with the CN 20. The MN identification information 47 includes the HoA and the ID (MN-ID) of the MN 10. The CoA option 46 and the MN identification information 47 may be included not only as options of the mobility header 44 but also as another destination option header.

Referring again to FIG. 4, following the selection by the address selection unit 105 of a desired address (CoA1) to be used for the route optimization with the CN 20, the CoTI generation unit 106 generates a CoTI message for the selected address CoA1, further adds MN identification information thereto, and transmits the resultant to the CN 20. This MN identification information may function as CoA comparison request information requesting the CN 20 receiving the CoTI message to make a comparison with the HoTI message corresponding to the CoTI message. That is, when the CoTI message includes the MN identification information, the CN 20 understands that comparison has to be made with the corresponding HoTI message. As the MN identification information, an option added to the CoTI message may be used, for example. Such an option includes the HoA and the ID of the MN 10, allowing the CN 20 to identify the sender node of the received CoTI message. The CoTI generation unit 106 may incorporate numerical information such as a sequence number or a cookie to allow the CN 20 to understand a correspondence relationship between the HoTI message and the CoTI message.

### <CoTI>

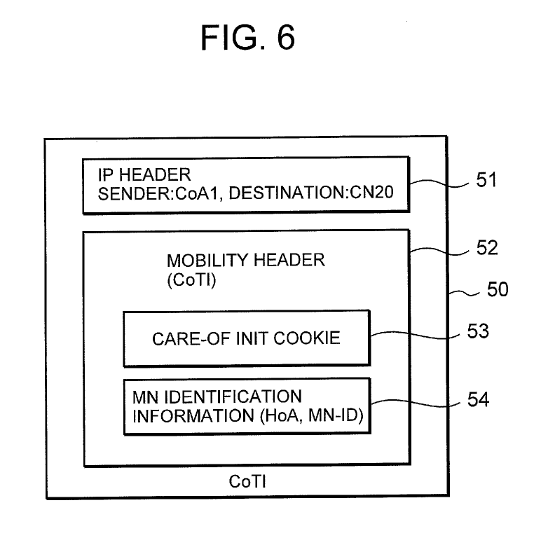

FIG. 6 shows a CoTI message 50 generated by the CoTI generation unit 106. The CoTI message 50 includes an IP header 51 and a mobility header 52, and is a message directly transmitted to the CN 20 using the care-of address registered with the CN 20. Therefore, the sender address of the CoTI message 50 is CoA1 (refer to the IP header 51). The mobility header 52 includes a normal cookie for care-of test (Care-of Init Cookie) 53 as well as MN identification information 54 as an option. The MN identification information 54 includes the HoA and/or the ID of the MN 10. The MN identification information 54 may be included not only as an option of the mobility header 52 but also as another destination option header.

Referring again to FIG. 4, the HoT processing unit 107 processes a HoT message received via the HA 30, which is returned from the CN 20 in response to the transmitted HoTI messages 40 and 42, and keeps, in the address management unit 109, various types of information (e.g., home keygen token for MAC generation) included in the HoT message. The CoT processing unit 108 processes a CoT message returned from the CN 20 in response to the transmitted CoTI message 50, and keeps, in the address management unit 109, various types of information (e.g., care-of keygen token for MAC generation) included in the CoT message. The MIP control unit 110 generates authentication information (MAC) using the information (e.g., home keygen token and care-of keygen token) acquired by the HoT processing unit 107 and the CoT processing unit 108, adds the authentication information (MAC) to a BU message for registration of association information between HoA1 and CoA1, and transmits the resultant to the CN 20.

### <HA>

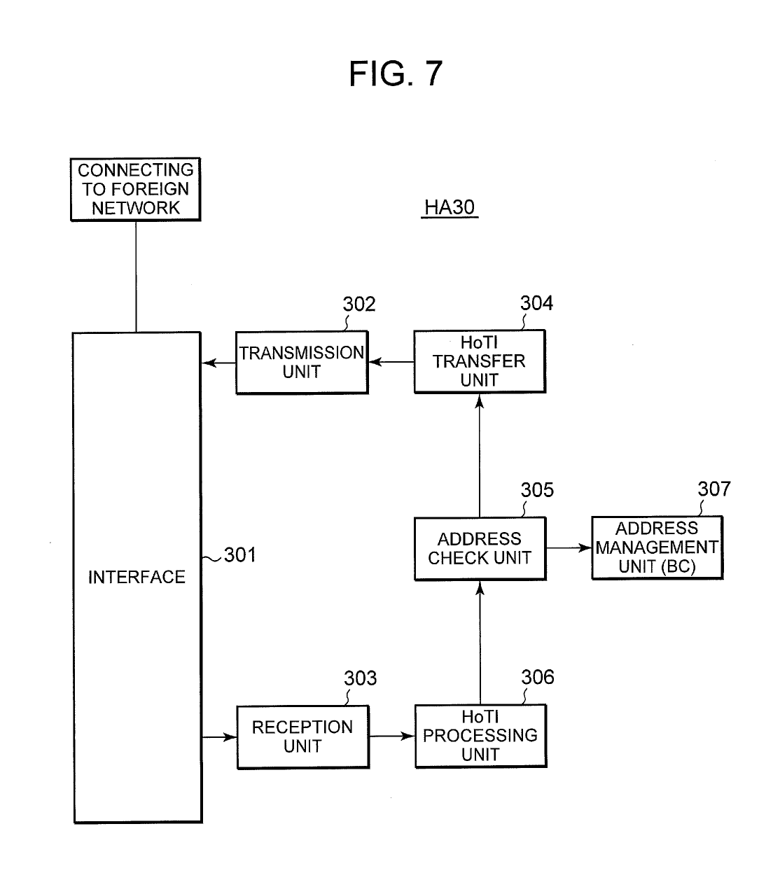

FIG. 7 shows the configuration of the HA 30 in Embodiment 1 of the present invention. The HA 30 includes an interface 301, a transmission unit 302, a reception unit 303, a HoTI transfer unit 304, an address check unit 305, a HoTI processing unit 306 and an address management unit 307. The HoTI processing unit 306 processes the encapsulated HoTI message 40 from the MN 10 and passes the resultant to the address check unit 305. The address management (BC) unit 307 functions as a binding cache (BC) that keeps positional information registered by the MN 10. The address management unit 307 further keeps various types of information that is considered by the address check unit 305 to select an address to be used for route optimization, which will be described later. The address management unit 307 further may function as a BC that keeps association information between HoA1, CoA1 and CoA2.

The address check unit 305 checks the sender address (CoA) set in the external IP header 41 and the care-of address (CoA1) in the CoA option 46 of the HoTI message 40 encapsulated as shown in FIG. 5, and checks as to whether such an address CoA1 is an address permitted for use in route optimization or not. In order to check whether the address CoA1 is an address permitted for use in route optimization or not, available methods include checking whether the addresses CoA and CoA1 are CoAs registered with the address management unit 307 (BC) or not or checking whether these addresses are generated from a prefix managed by a network operator or not.

When the result of checking the address CoA1 included in the CoA option 46 in the received HoTI messages 40, 42 shows that the address CoA1 is an address permitted, the address check unit 305 transfers the HoTI message 42 as the internal packet to the CN 20. On the other hand, when the address CoA1 is not an address permitted, the address check unit 305 discards the HoTI messages 40 and 42 without transferring them. When the address is not an address permitted, the address check unit 305 may transmit a response message notifying the MN 10 that the HoTI messages 40 and 42 are discarded, while discarding the HoTI messages 40 and 42.

The address check unit 305 further may check the address CoA set as the sender address of the external IP header 41 while checking the CoA option 46. Basically according to mobile IP, in order to allow the MN 10 to encapsulate a packet and transmit the same to the HA 20, the sender address CoA of the external IP header 41 of the encapsulated packet has to be a care-of address already registered with the HA 20, and therefore checking is performed as to whether the sender address CoA of the external IP header 41 is a care-of address already registered or not.

That is, in order to allow the address check unit 305 to check the sender address of the external IP header 41, the MN 10 normally has to transmit the HoTI messages 40 and 42 using a care-of address registered with the HA 20. Additionally, the MN 10 has to transmit a BU message prior to the transmission of the HoTI messages 40 and 42 so as to register a care-of address used for transmission of the HoTI messages 40 and 42. As for the above-stated checking of the address CoA1 included in the CoA option 46 and the address CoA set as the sender address of the external IP header 41, these addresses CoA1 and CoA preferably are identical, but they do not have to be always identical. As long as the address CoA1 included in the CoA option 46 is an address permitted for route optimization and the sender address CoA of the external IP header 41 is an address already registered with the HA 20, the internal HoTI message 42 will be transferred without being discarded by the HA 20.

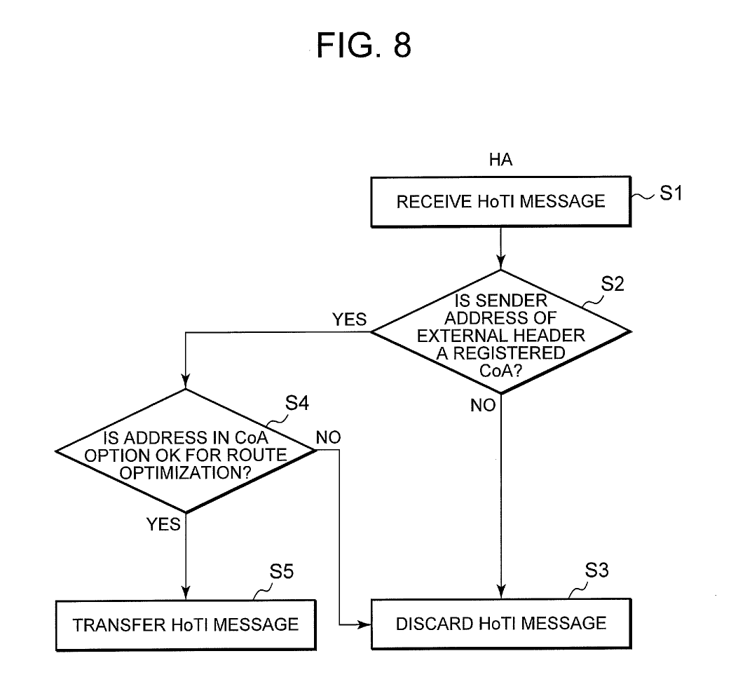

FIG. 8 is a flowchart showing the address processing by the address check unit 305. In FIG. 8, when receiving the HoTI message 40 (Step S1), the address check unit 305 checks whether the sender address CoA of the external IP header 41 is a registered CoA or not (Step S2). If it is not a registered CoA, the address check unit 305 discards the HoTI message 40 (Step S3), and if it is a registered CoA, the address check unit 305 checks whether CoA1 in the CoA option 46 is OK for route optimization or not (Step S4). If it is OK for route optimization, the address check unit 305 instructs the HoTI transfer unit 304 to transfer the decapsulated HoTI message 42 to the CN 20 (Step S5), and if it is not OK for route optimization, the address check unit 305 discards the HoTI message 40 (Step S3). Herein, when the address check unit 305 permits to transfer the HoTI message 40 received from the MN 10, the HoTI transfer unit 304 shown in FIG. 7 transfers the HoTI message 42 subjected to decapsulation to the CN 20.

In addition to such checking of the sender address CoA of the external IP header 41 based on mobile IP, the HA 20 may determine the acceptance or not of the HoTI message 40 based on as to whether these addresses CoA and CoA1 are identical or not. In this case, if the sender address CoA of the external IP header 41 is a care-of address registered with BC but is different from the address (address CoA1 included in the CoA option 46) used for route optimization, the HA 20 does not transfer the HoTI message 42 to the CN 20. That is, as for the HoTI message 42 transferred by the HA 20, the address CoA1 used for route optimization has to be an address already registered with the HA 20 as well. Such checking allows the HA 20 to confirm that the transmission node of the HoTI message 40 is the owner of the address included in the CoA option 46.

As criteria for determining as to whether the HA 20 accepts the HoTI message 40 or not, in order to enable the MN 10 to quickly configure a route optimization path, the address CoA1 included in the CoA option 46 has to be an address permitted for route optimization even when the HoTI message 40 is not transmitted from the care-of address already registered with the HA 20. In this case, the encapsulated HoTI message 40 may be received and the HoTI message 42 may be transferred. Thereby, if an address not used for communication via the HA 20 but used for route optimization exists, the MN 10 simply may transmit the HoTI message 40 only using such an address, thus eliminating the necessity to transmit a BU message. Note here that, in this case, in order to check that the transmission node of the HoTI message 40 is the owner of the address included in the CoA option 46, it is preferably required as a condition that the sender address CoA of the external IP header 41 and the address CoA1 of the CoA option 46 are identical.

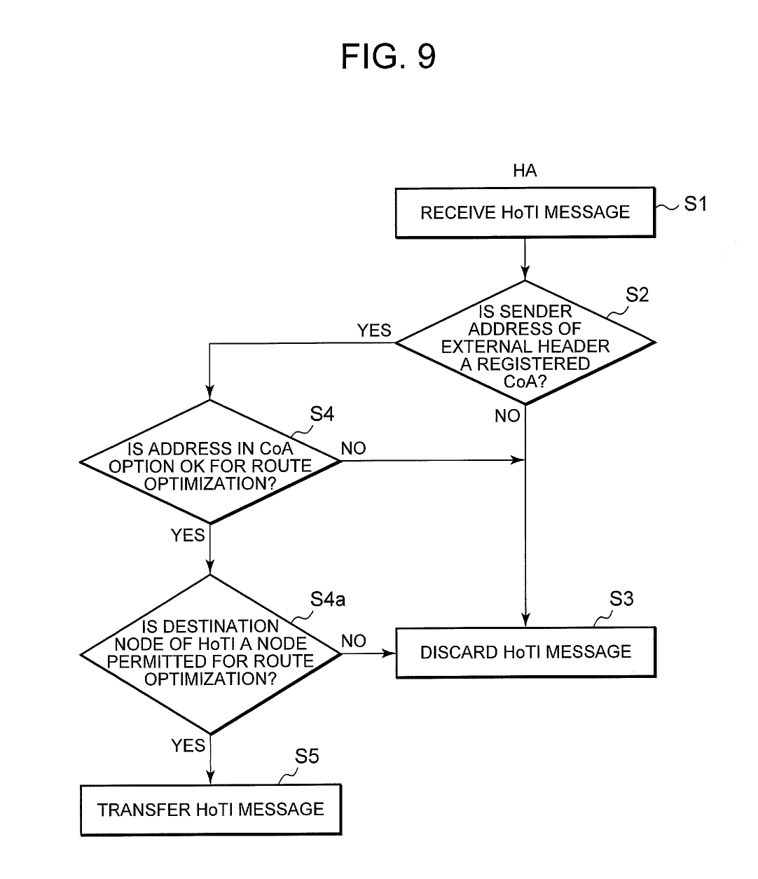

As shown in FIG. 9 as a modification example of FIG. 8, following the determination by the address check unit 305 that the HoTI messages 40 and 42 are accepted (Yes at Step S3, Yes at Step S4) and prior to actual transferring of the HoTI message 42 to the CN 20, the address check unit 305 may determine whether the HoTI message 42 should be transferred or not based on the CN 20 as a destination of the HoTI message 42 as the internal packet corresponding to the CN in Embodiment 1 of the present invention or not or whether the CN 20 being a node permitted for route optimization or not (Step S4a). Whether the CN 20 corresponding to such a CN or not or whether being permitted or not may be determined by the following methods, that is, the HA 30 may ask an authentication server thereabout or a database that the HA 30 itself has may be used. Herein, FIG. 9 is different from FIG. 8 only in that Step S4a is added after Step S4 of FIG. 8, and therefore the detailed description thereof has been omitted.

### <CN>

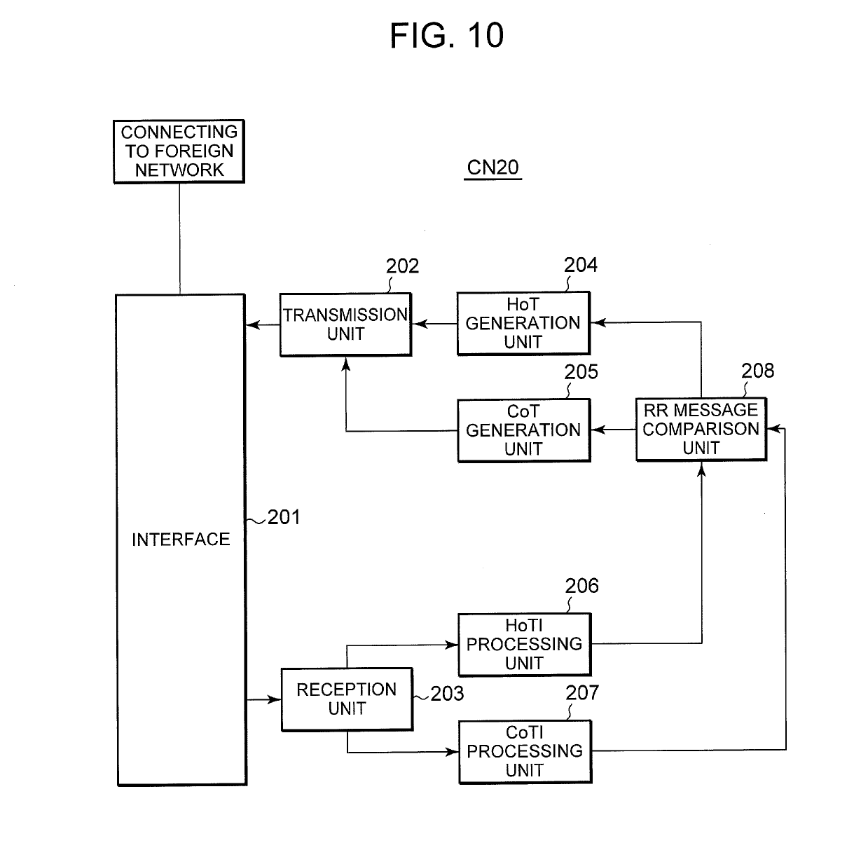

FIG. 10 shows the configuration of the ON 20 in Embodiment 1 of the present invention. The CN 20 includes an interface 201, a transmission unit 202, a reception unit 203, a HoT generation unit 204, a CoT generation unit 205, a HoTI processing unit 206, a CoTI processing unit 207, and a RR (Return Routability) message comparison unit 208. The transmission unit 202 has a function to transmit a packet to a node on a network (foreign network 2) connected via the interface 201. The reception unit 203 has a function to receive a packet from a node on a network (foreign network 2) connected via the interface 201.

The HoTI processing unit 206 receives a HoTI message 42 received from the MN 10 via the HA 20, and when the HoTI message 42 includes a CoA option 46, the HoTI processing unit 206 instructs the RR message comparison unit 208 to perform comparison processing with a CoTI message 50 corresponding to the HoTI message 42. The CoTI processing unit 207 receives a CoTI message 50 received from the MN 10, and when the CoTI message 50 includes MN identification information, the CoTI processing unit 207 instructs the RR message comparison unit 208 to perform comparison processing with a HoTI message 42 corresponding to the CoTI message 50.

When verification by the RR message comparison unit 208 results in permission of reception of the HoTI message 42, the HoT generation unit 204 generates a HoT message in accordance with the stipulation of mobile IP, and such a message is transmitted to the MN 10 via the HA 30. Similarly, when verification by the RR message comparison unit 208 results in permission of reception of the CoTI message 50, the CoT generation unit 205 generates a CoT message in accordance with the stipulation of mobile IP, and such a message is transmitted to the MN 10.

Receiving an instruction from the HoTI processing unit 206 and the CoTI processing unit 207, the RR message comparison unit 208 compares the address CoA1 included in the CoA option 46 added to the HoTI message 42 and the sender address CoA1 of the CoTI message 50 corresponding to the HoTI message 42. Then, if these addresses are identical, the RR message comparison unit 208 permits the reception of the HoTI message 42 and the CoTI message 50, and instructs the HoT generation unit 204 and the CoT generation unit 205 to transmit a HoT message and a CoT message. On the other hand, if these addresses are different, the RR message comparison unit 208 discards the corresponding HoT message and CoT message. In order to identify the corresponding HoTI message 42 and CoTI message 50, the HoA and/or the ID of the MN included in both of the messages 42 and 50 are used.

The RR message comparison unit 208 uses a timer to measure, after receiving one of the HoTI message 42 and the CoTI message 50 earlier, time to wait for the arrival of the other message corresponding thereto. For instance, when the CoTI message 50 is received earlier, the RR message comparison unit 208 starts the timer with the reception of the message, and waits for the arrival of the HoTI message 42 for a predetermined time period only. If the HoTI message 42 cannot be received within the predetermined time period, the RR message comparison unit 208 discards the earlier received CoTI message 50.

The following considers the case where the MN 10 wants to use CoA2 for route optimization, but a network operator permits CoA1 and not CoA2. In the case where the CN 20 is a conventional CN, in order to transfer the HoTI message 42 from the HA 30 to such a conventional CN 20, the MN 10 incorporates CoA1 permitted by the HA 30 in a CoA option and transmits such a HoTI message from CoA1, while transmitting a CoTI message 50 from CoA2, whereby the MN 10 can acquire both of home keygen token (included in a HoT message) and care-of keygen token (included in a CoT message). Thereby, registration of positional information for CoA2, which is not permitted by a network operator, will be permitted for the MN 10. However, as described in the present embodiment, home keygen token is returned only when the CN 20 receives the CoTI message 50 corresponding to the received HoTI message 42, whereby the MN 10 can acquire the home keygen token and the care-of keygen token for CoA1 only, thus avoiding registration of CoA2.

Thusly, according to Embodiment 1, instead of checking the sender address only of the HoTI message 40 as in Patent Document 1, the HA 30 checks the care-of address (CoA1) included in the CoA option 46 in the internal HoTI message 42, and therefore transferring of a HoTI message 42, if it is not permitted for route optimization, can be avoided. Additionally, although the MN 10 can acquire care-of keygen token for an address permitted by a network operator, the MN 10 cannot acquire care-of keygen token for an address not permitted by a network operator. This is because even when a HoTI message 42 can be transferred to the CN 20 using an address permitted by a network operator, the CoTI message 50 corresponding to the HoTI message 42 similarly has to be a CoTI message concerning the address permitted by the network operator. Therefore, the MN 10 cannot generate authentication information accepted by the CN 20 and add the same to a BU message to register an address not permitted by a network operator. As a result, route optimization using an address not permitted by a network operator can be avoided.

### Embodiment 2

In Embodiment 1, the CN 20 compares the sender address of the CoA option 46 in the HoTI message 42 with the sender address of the CoTI message 50. Instead, Embodiment 2 of the present invention uses another generation method to generate Home Keygen Token included in a HoT message. More specifically, when receiving a HoTI message 42 including a CoA option 46, a CN 20 generates Home Keygen Token using not only HoA but also a care-of address included in the CoA option. The following is a generation method of Home Keygen Token in the present embodiment:

_home keygen token:=First(64,HMAC_SHA1(Kcn,(home address|care-of address|nonce|0))).

A normal generation method of Home Keygen Token is exemplified below:

home keygen token:=First(64,HMAC_SHA1(Kcn,(home address|nonce|0))).

A normal mobile node generates a binding management key Kbm from home keygen token in the HoT message received from the CN 20 and care-of keygen token in a CoT message, and further generates a message authentication code (MAC) as authentication information from the binding management key Kbm and transmits the same to the CN 20 with a BU message. The CN 20 compares the message authentication code in the received BU message with a message authentication code calculated by itself for authentication of the BU message.

Unlike the normal method of generating home keygen token, since the generation method of the present embodiment adds a care-of address to generate home keygen token, home keygen token and care-of keygen token that the MN 10 uses to generate a message authentication code have to be included in the HoT message and the CoT message corresponding to the same care-of address.

For instance, the following considers the case where the MN 10 wants to use CoA2 for route optimization, but a network operator permits CoA1 and not CoA2. In this case, in order to transfer the HoTI message 42 from the HA 30 to the CN 20, the MN 10 transmits a HoTI message 40 from CoA1 permitted by the HA 30, while transmitting a CoTI message 50 from CoA2, whereby the MN 10 can acquire both of home keygen token and care-of keygen token. Therefore, when the CN 20 generates home keygen token using HoA only as in the conventional techniques (i.e., without adding care-of address), the MN 10 can generate a message authentication code that the CN 20 will accept. Thereby, registration of positional information for CoA2, which is not permitted by a network operator, will be permitted for the MN 10.

According to the present embodiment, however, a BU message can be rejected by detecting disagreement between authentication information (authentication information generated using home keygen token generated from CoA1) added by the MN 10 and authentication information generated by the CN 20. This is because even when the CN 20 generates home keygen token by adding CoA1 included in the HoTI message 42, whereby the MN 10 generates authentication information from the acquired home keygen token (generated using CoA1) and the care-of keygen token for CoA2 (generated using CoA2) and adds the resultant to a BU message to register CoA2 for transmission, the CN 20 receiving such a BU message checks the authentication information by generating home keygen token using CoA2.

Instead of generating home keygen token using CoA1, the CN 20 may use HoA1 included in the CoTI message 50 to generate care-of keygen token. In this case, the care-of keygen token will be generated as follows:

care-of keygen token:=First(64,HMAC_SHA1(Kcn,(care-of address|home address|nonce|1))).

Both of the above-stated home keygen token generated using CoA1 and care-of keygen token generated using HoA1 may be used at the same time.

A HoT message and a CoT message may include information indicating that the home keygen token and the care-of keygen token included in the HoT message and the CoT message are generated by the above-stated method. For instance, the CN 20 may set such information as a flag in a mobility header configuring the HoT message and the CoT message, or a specific value may be set in a MH type (Mobility Header type) of the mobility header. Alternatively, such information may be set as a flag in the CoA option 46 so as to be included in the HoT message and the CoT message.

In this way, similarly to Embodiment 1, Embodiment 2 also can avoid transferring of the HoTI message 42 that is not permitted for route optimization because the HA 30 checks the care-of address included in the CoA option 46 of the HoTI messages 40 and 42. Further according to Embodiment 2, even when a HoTI message 42 is transferred to the CN 20 using the address permitted by a network operator and home keygen token can be acquired, home keygen token for an address not permitted by the network operator cannot be acquired. Accordingly, the MN 10 cannot generate authentication information accepted by the CN 20 and add the same to a BU message to register an address not permitted by a network operator. As a result, route optimization using an address not permitted by a network operator can be avoided.

### Embodiment 3

Embodiment 1 and Embodiment 2 of the present invention describe the method of allowing the HA 30 to reject RR started by the MN 10 when the MN 10 tries to use an address acquired in a local network to configure a route optimization path P2. Embodiment 3 of the present invention describes a method to enable the configuration of a route optimization path P2 using an address acquired in a local network. Since the network configuration in the present embodiment is similar to that of Embodiment 1, the following description refers to FIG. 2.

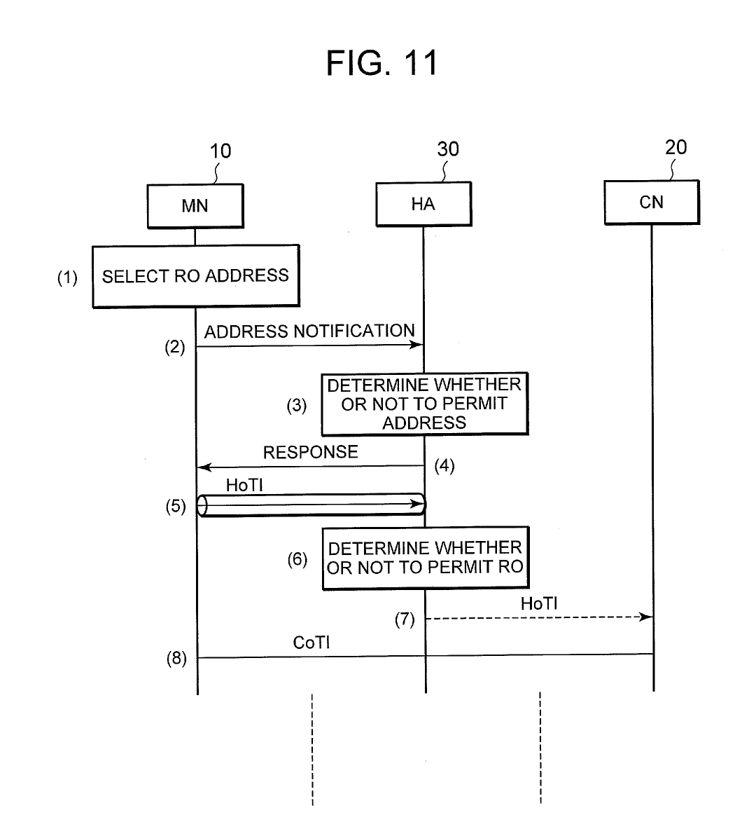

Firstly, the outline of the present embodiment is given below. Assume that, as shown in FIG. 2, a MN 10 in the present embodiment wants to perform communication with a CN 20 with a route optimization path using an address (CoA1) acquired in a local network, i.e., using a local network-through path P21. FIGS. 11(1) to (8) shows a communication sequence in Embodiment 3.

(1) Firstly, the MN 10 selects CoA1 as an address that the MN 10 wants to use for route optimization (RO) from addresses (CoA1, CoA2) that the MN 10 has.

(2) After selecting CoA1 as an address used for route optimization, if CoA1 is not an address allocated from a 3GPP network 1a but is an address allocated from a local network, the MN 10 transmits, to the HA 30, a route optimization request message requesting to permit the transferring of a HoTI message including CoA1.

(3) Receiving the route optimization request message, the HA 30 checks whether CoA1 is permitted for use in route optimization.

(4) If it is determined that route optimization using CoA1 is permitted, the HA 30 transmits a response to the MN 10, indicating permission of the route optimization using CoA1.

(5) (8) Receiving the response, similarly to Embodiment 1, the MN 10 transmits a HoTI message including CoA1 to the CN 20 via the HA 30 to configure a route optimization path using CoA1, while transmitting a CoTI message including CoA comparison request information to the CN 20, so as to start RR.

(6) (7) The HA 30 checks all packets transmitted by a UE, and when finding a packet including a HoTI message, the HA 30 checks the address included in the HoTI message against CoA1 notified by the route optimization request message. When the address included in the HoTI message is different from CoA1, the HA 30 does not transfer such a HoTI message (i.e., discards the message). On the other hand, when the address included in the HoTI message is CoA1, the HA 30 transfers the HoTI message to the CN 20. Similarly to Embodiment 1, the CN 20 compares the address in the HoTI message with the sender address of the CoTI message, and only when they are identical, the HA 30 returns a HoT message and a CoT message to the MN 10 (not shown).

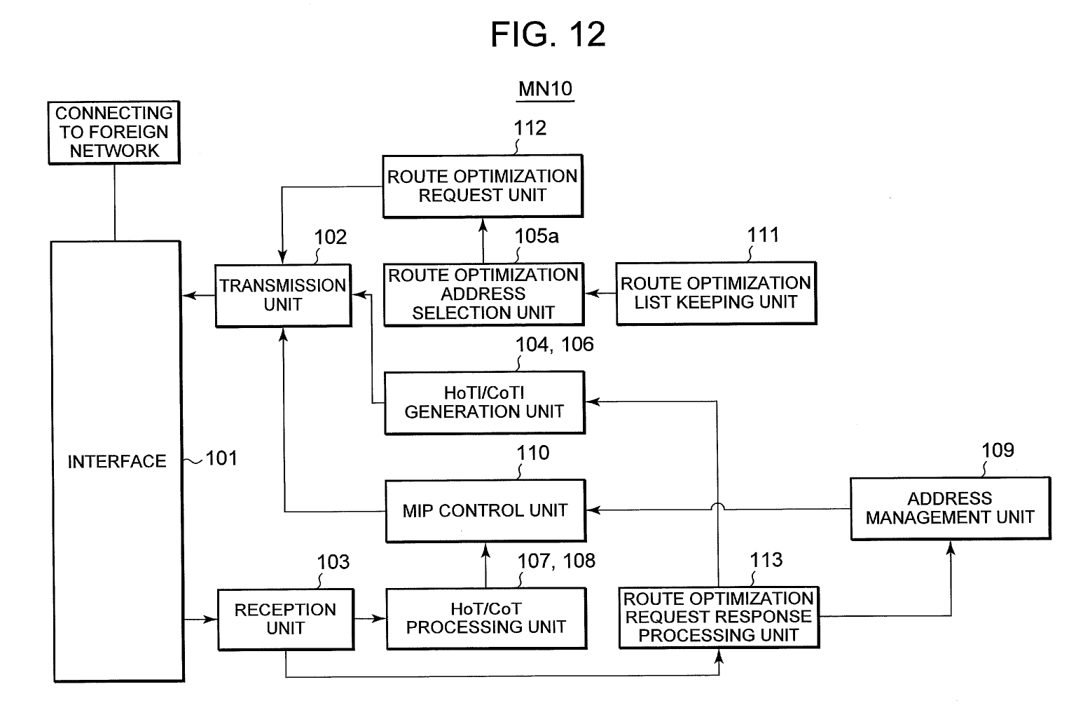

FIG. 12 exemplifies the configuration of functions that the MN 10 in Embodiment 3 has. An interface 101, a transmission unit 102, a reception unit 103, HoTI/CoTI generation units 104 and 106, HoT/CoT processing units 107 and 108, an address management unit 109, and a MIP control unit 110 in FIG. 12 have the same configuration as those in FIG. 4, and therefore the detailed description thereof has been omitted. A route optimization address selection unit 105a selects an address used for route optimization. This selection corresponds to the selection of a path used for route optimization. For instance, this selection is performed based on determination which path is optimal for communication with the CN 20. In this case, as shown in FIG. 2, since the CN 20 is a node not existing on the 3GPP network 1a but on a foreign network (on the Internet), it is determined that a local network-through path P21 directly connecting with the Internet from a local network with which the MN 10 connects is shorter than the ePDG-through path P21 and the HA-through path P1, and therefore CoA1 is selected. Further, when it is found that, similarly to the MN 10, the CN 20 also is a node connecting with a Non-3GPP network 1b and capable of using the local network-through path P21, the MN 10 can select the local network-through path P21.

Based on determination as to whether the local network (Non-3GPP network 1b) with which the MN 10 connects is a trusted Non-3GPP network or an untrusted Non-3GPP network, a route optimization address may be selected. For instance, since the trusted Non-3GPP network has a close relationship with a 3GPP operator, a 3GPP operator can control accounting, for example, based on the status and various types of information on the Non-3GPP network, and therefore the 3GPP operator may permit route optimization from the trusted Non-3GPP network. Therefore, when the network connecting is a trusted Non-3GPP network, the MN 10 selects an address allocated to the interface 101 as an address used for route optimization.

Unlike the above, when the network connecting is an untrusted Non-3GPP network, the MN 10 may select an address allocated to the interface 101 as an address used for route optimization. For instance, connecting process and a length of a connecting path from a trusted Non-3GPP network to a 3GPP core network can be considered relatively favorable than that from an untrusted Non-3GPP network. Thus, an advantage obtained from using the local network-through path P21 instead of the HA-through path P1 in the trusted Non-3GPP network may not be so big. On the other hand, when the untrusted Non-3GPP network is a network not managed by a 3GPP operator (public wireless LAN), complicated process has to be executed to connect with a 3GPP core network, leading to the possibility of a long connecting path. In this case, even when the network connecting is an untrusted network, an advantage for the MN 10 obtained from selecting the local network-through path P21 is considerable.

A route optimization address may be selected based on a route optimization information list that a route optimization list keeping unit 111 of the MN 10 keeps. The route optimization information list contains information concerning a network (Non-3GPP network 1b) from which addresses that can be used for route optimization can be acquired. For instance, when the local network connecting is a network included in the list, an address allocated from the network is selected as an address used for route optimization. On the other hand, when the local network connecting is not a network included in the list, it is determined that such a network cannot be used for route optimization and an address allocated from the network is not selected.

The MN 10 further may select an appropriate path depending on the type of a flow (e.g., Web flow, video flow, audio flow and data flow) exchanged in a communication with the CN 20. For instance, assuming that the type of a flow exchanged with the CN 20 is flow A, and when flow information that the MN 10 keeps stipulates that the flow A is transferred using the local network-through path P21, the MN 10 selects CoA1 as an address used for route optimization. When the MN 10 has a flow that is stipulated to use route optimization, an address may be selected using the above-stated method. In this case, when the flow exchanged with the CN 20 is flow A that is stipulated to be transferred using the local network-through path P21, the MN 10 checks whether the network connecting is a trusted network or not, and when it is a trusted network, the MN 10 selects the allocated address as an address for route optimization.

The flow information that the MN 10 refers to may be flow information acquired from an operator (HPLMN: Home Public Land Mobile Network, home operator) of the 3GPP network 1a or an operator (VPLMN: Visited Public Land Mobile Network, roaming destination operator) managing a local network, or may be flow information that the MN 10 keeps beforehand. When it is acquired from an operator, the flow information may be information acquired from an ANDSF (Access Network Discovery and Selection Function) server using ANDSF, or may be acquired directly from a policy server such as PCRF (Policy Control and Charging Function) or via the HA 30, for example.

After selection of CoA1 as an address for route optimization using the above-stated method, the route optimization address selection unit 105a instructs a route optimization request unit 112 to notify the HA 30 of a route optimization request message so as to request the HA 30 to use route optimization using CoA1. The route optimization request unit 112 generates the route optimization request message to request the HA 30 to use route optimization using the address selected by the route optimization address selection unit 105a and transmits the message via the transmission unit 102 and the interface 101.

After the selection of an address, the address selection unit 105 may determine as to whether a notification is given to the HA 30 or not depending on the selected address. For instance, when the operator permits route optimization using the address allocated from a trusted local network, and when the selected address is an address allocated from a trusted network, the address selection unit 105 determines that the address is permitted for use in route optimization, and may determine to start route optimization processing without transmitting a route optimization request message to the HA 30.

On the other hand, when the selected address is allocated from an untrusted network, the address selection unit 105 may transmit a route optimization request message to the HA 30. In this case, the MN 10 may request to use route optimization using CoA1 in an IKEv2 message exchanged with the ePDG 31, and the ePDG 31 receiving such a request may transmit a route optimization request message to the HA 30. For the route optimization request message transmitted to the HA 30 by the ePDG 31, a PBU (Proxy Binding Update) message may be used, but not limited to. Unlike the above, when the selected address is allocated from a trusted network, a route optimization request message may be transmitted to the HA 30 to notify about the selected address for identification, whereas when the address is allocated from an untrusted network, since such an address cannot be used for route optimization, it may be determined that there is no need of transmission to the HA 30. Even when the connecting network is an untrusted network, and when the selected address is CoA2 to use the ePDG-through path P11, it may be determined that a route optimization request message is to be transmitted. The HA 30 can understand the Local-CoA of the MN 10 by making an inquiry to the ePDG 31 or the like. In order to allow the HA 30 to easily understand the care-of address that the MN 10 requests to use for route optimization, the route optimization request message may include CoA1.

In another example, in order to determine whether a notice on the route optimization request message is to be given to the HA 30 or not, a route optimization information list may be used. In this case, when the connecting local network corresponds to a network corresponding to a network included in the list, it is determined that such a network is already permitted by the HA 30 for use in route optimization, and route optimization processing is started without requesting to the HA 30. On the other hand, when the network is not included in the list, it is determined that such a network cannot be used for route optimization, and route optimization request is not made. Unlike the above, when the connecting network is a network not included in the list, a request may be made to the HA 30 to use route optimization. Even when the connecting local network is a network included in the list, and when the operator does not permit the MN 10 to use route optimization, a notice may be given to the HA 30 that CoA2 is a desired address for execution of route optimization.

Prior to the referring to the route optimization information list, the MN 10 itself may check as to whether the use of route optimization is permitted or not. Permission of use means that subscription (subscriber information) on the MN 10 permits the MN 10 to use route optimization as a contract. Such checking may be performed by referring to the subscription that the MN 10 itself keeps or when the MN 10 itself keeps the route optimization information list, then it is determined that the use of route optimization is permitted. When a request for the route optimization information list to an information server (an ANDSF server, the HA 30, or a policy server (PCRF)) in the 3GPP network 1a results in successful acquisition of adequate information as the route optimization information list, it may be determined that route optimization is permitted. On the other hand, when such a request fails, it may be determined that route optimization is not permitted.

The route optimization information list may contain information on a flow to be transferred using the route optimization instead of the above-stated information on a network that is permitted for use in route optimization. For instance, when it is instructed to transfer a flow in a communication with the CN 20, or a flow supposed to be exchanged therewith via a path (local network-through path P21) directly accessible to the Internet or the like from a local network, the MN 10 selects CoA1.

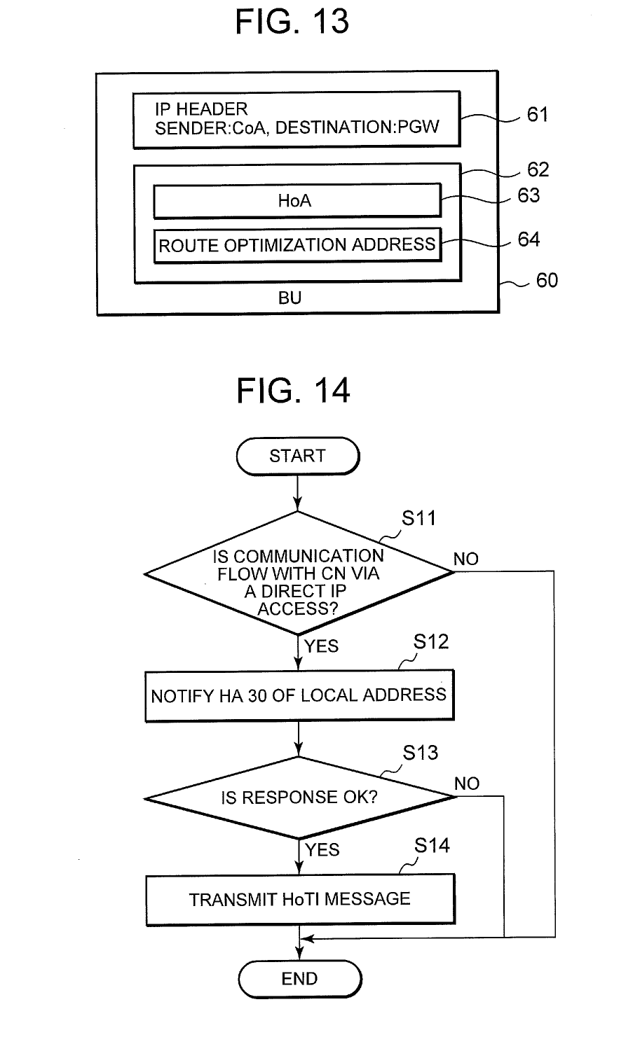

As shown in FIG. 13, when requesting from the HA 30 for route optimization using CoA1, the MN 10 in Embodiment 3 incorporates the request in a BU message 60 transmitted to the HA 30 for notification. The BU message 60 includes CoA1 as a sender address and an address of PGW (HA 30) as a destination address in an IP header 61, and includes a HoA 63 and a route optimization address 64 in a payload 62. FIG. 13 shows a non-limiting example where CoA1 is included in the BU message 60 so as to indicate a request for route optimization using Local-CoA. Instead of including CoA1, a flag in the BU message may be used to request route optimization using Local-CoA. The BU message 60 for notification of the route optimization address may be a BU message to register, with the HA 30, an address (ePDG-CoA: CoA2) acquired from the ePDG (evolved Packet Data Gateway) 31 as a care-of address associated with HoA1. In this case, the BU message includes, as well as CoA2 registered as a care-of address, CoA1 for route optimization address or a flag set thereto. When CoA1 is included, a field 64 including CoA1 uses a different type of option or includes a flag set in an option so as to distinguish from an alternative CoA option including CoA2. The method of notification of a route optimization request using Local-CoA is not limited to the BU message 60. As another method, notification may be performed in IKEv2 (IKE_SA_INIT, IKE_AUTH_Request or the like) transmitted/received to establish SA with the HA 30, or in IKEV2 (IKE_SA_INIT, IKE_AUTH_Request or the like) executed to establish SA between the ePDG 31 and the MN 10.

The route optimization address selection unit 105a further instructs the address management unit 109 to keep the address selected as route optimization address. A route optimization request response processing unit 113 processes a response returned from the HA 30 in response to the transmitted route optimization request, and the HoTI/CoTI generation units 104, 106 transmit or do not transmit a HoTI message and a CoTI message depending on the processing result.

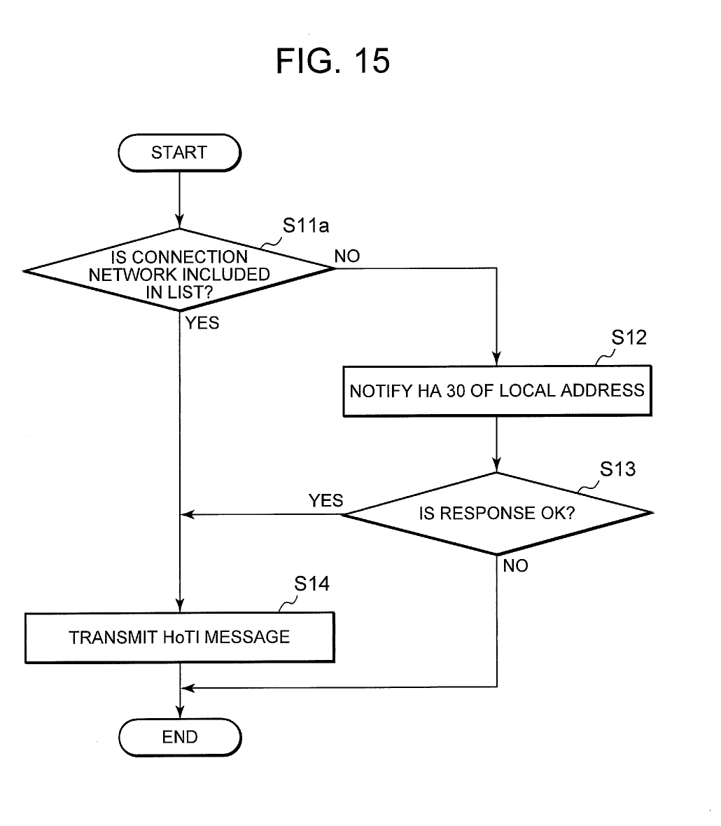

FIG. 14 and FIG. 15 are flowcharts exemplifying the processing by the MN 10. In the example of FIG. 14, checking is performed as to whether a communication flow with the CN 20 is via a direct IP access or not (Step S11). In the case of YES, the MN 10 notifies the HA 30 of a local address as a route optimization address (Step S12), and if a response from the HA 30 is OK (YES at Step S13), the MN 10 transmits a HoTI message (Step S14). FIG. 15 is a flowchart exemplifying the case where information on a network permitted for route optimization by the HA 30 is included in the route optimization list. Firstly, checking is performed as to whether a connecting network is included in a route optimization list or not (Step S11a). In the case of YES, the MN 10 transmits a HoTI message (Step S14). On the other hand, in the case of NO, the MN 10 notifies the HA 30 of a local address as a route optimization address to make a request for route optimization (Step S12). If a response from the HA 30 is OK (YES at Step S13), the MN 10 transmits a HoTI message (Step S14).

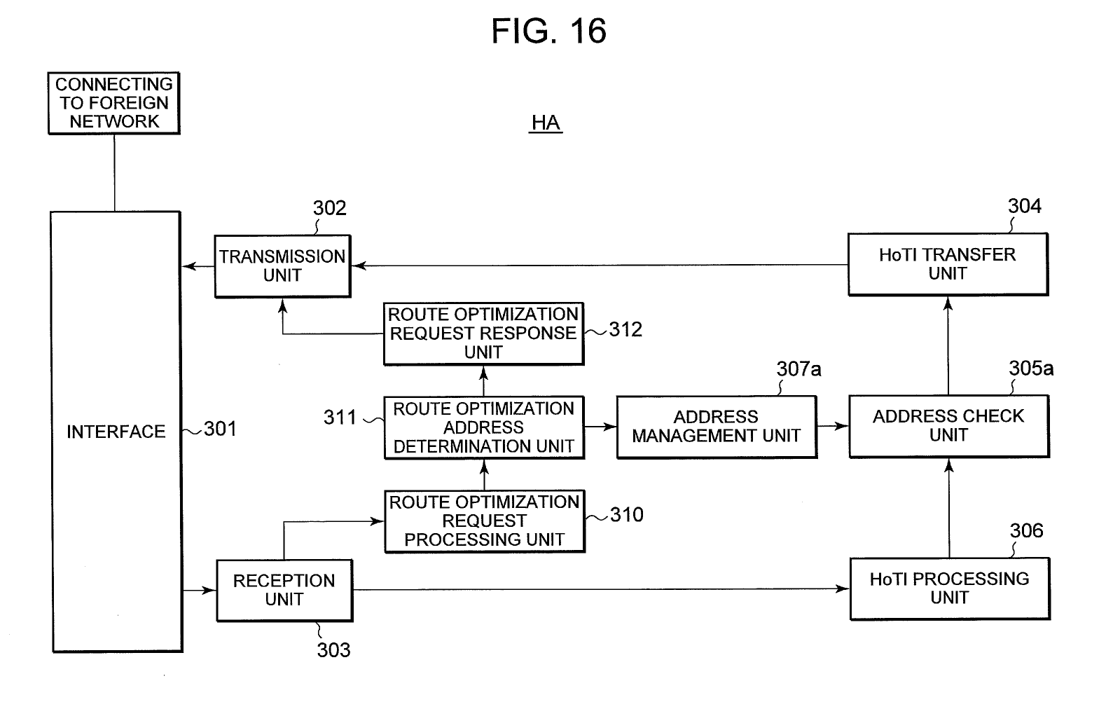

FIG. 16 exemplifies the configuration of the HA 30 in Embodiment 3. An interface 301, a transmission unit 302, a reception unit 303, a HoTI transfer unit 304 and a HoTI processing unit 306 in FIG. 15 are the same as the configuration of those in FIG. 7, and an address check unit 305a and an address management unit 307a have substantially the same configuration as those in FIG. 7, and therefore the detailed description thereof has been omitted. A route optimization request processing unit 310 acquires a route optimization address notified from the MN 10, and passes the same to a route optimization address determination unit 311. The route optimization request processing unit 310 may acquire the route optimization address from the ePDG 31.

The route optimization address determination unit 311 determines as to whether route optimization using an address notified from the MN 10 is permitted to the MN 10 or not. Determination may be performed by checking the address against a route optimization information list (not shown) that the HA 30 keeps so as to check whether the address is allocated from a network included in the list (network permitted for route optimization) or when a prefix permitted for route optimization is included in the list, by checking whether the prefix of the notified address agrees with a prefix in the list or not. Such a checking method is not a limiting one.

Before the determination as to whether the address notified from the MN 10 is an address useable for route optimization or not, the route optimization address determination unit 311 may inquire an AAA/HSS (not shown) for confirmation as to whether the MN 10 is a node permitted for use in route optimization. When receiving the inquiry, the HSS/AAA refers to subscriber information (Subscription) on the MN 10 so as to check whether the MN 10 is a node permitted for route optimization using a local address or not. When receiving a response indicating that the MN 10 is a node permitted for route optimization from the HSS/AAA, the HA 30 further checks whether route optimization using CoA1 is possible or not. Checking whether the route optimization using CoA1 is possible or not may be performed using the above-stated methods. For instance, checking may be performed based on whether the network allocating CoA1 being a network that a 3GPP operator can trust or not. In addition to the checking as to whether the UE 10 is a node permitted for route optimization, the HA 30 may inquire the HSS/AAA at the same time about as to whether route optimization using CoA1 is possible or not. When the result shows that route optimization using CoA1 is permitted, a route optimization request response unit 312 returns a response to the MN 10 indicating that the use of the notified address for route optimization is permitted.

When the route optimization request message is transmitted using a HA-through path P1, a sender address thereof is HoA1 of the MN 10 or CoA2, and therefore the HA 30 cannot confirm validity and reachability of CoA1 included in the message. Then, in order to check whether CoA1 notified from the MN 10 is surely the address that the MN 10 keeps, the HA 30 receiving the route optimization request message from the MN 10 may transmit an inquiry message including Cookie information to the notified address. A non-limiting example of the message inquiring an address includes an ICMP (Echo Request) message used for a Ping message. When receiving the inquiry message from the HA 30, the MN 10 returns a response message (Echo Reply) including the Cookie information included in the message to the HA 30. When receiving a response message including correct Cookie, the HA 30 determines that CoA1 is an address that the MN 10 keeps, and checks whether the address is permitted for route optimization or not as described below.

In order to improve a security level, it is preferable to execute both of the checking by an address inquiry message and the inquiry to the HSS/AAA. However, if the inquiry to the HSS/AAA suffices, the checking by an address inquiry message may be omitted. If the checking by an address inquiry message suffices, the inquiry to the HSS/AAA may be omitted.

According to Embodiment 3 of the present invention, a 3GPP network operator can control, depending on the MN 10, as to whether an address acquired from a local network is to be used for route optimization or not. The permitted MN 10 can use the local network-through path P21 to generate a route optimization path, and even when the local network-through path P21 is used after a handover from a 3GPP network to a Non 3GPP network, a session with the CN 20 using HoA1 can be maintained.

### Embodiment 4

Embodiment 4 describes the case where a UE connects with a macro base station (evolved Node B (eNB), Node B, macro cell) or a femto base station (called home evolved Node B (Home eNB, hereinafter called HeNB), home Node B (Home NB), home base station, compact base station, proxy base station or CSG (Closed Subscriber Group) cell) as well) in 3GPP, a path linking to a 3GPP network via the macro base station or the HeNB and a path directly linking with a foreign network (the Internet) via the macro base station or the HeNB are configured. Although the following describes the case of a HeNB, the same applies to the case of a macro base station.

A HeNB is a compact home base station providing a wireless cover area smaller than that of a macro base station. When the HeNB is installed in a user's house, a UE can access not only a 3GPP core network via the HeNB (hereinafter called a 3G-through path) but also a local network under the control of the HeNB (LIPA: Local IP Access) or directly the Internet not via a 3GPP core network (SIPTO: Selected IP Traffic Offload, hereinafter called direct path). Normally a UE uses a 3G-through path for the Internet access. However, when the UE connects with a HeNB, the UE can select a direct path not via a 3G-through path, whereby a flow can be transmitted directly to the Internet from the HeNB. The usage of the direct path leads to an advantage that a load on a 3GPP core network can be suppressed. As a further advantage, there is no need to perform communication via the 3GPP core network when the UE communicates with a node on the Internet, thus suppressing a load on a 3GPP core network and enabling communication in the shortest path. The present embodiment describes a method for allowing a HeNB to control availability of a direct path depending on a UE, in order for an operator to permit the use of a direct path to the UE as one of the services.

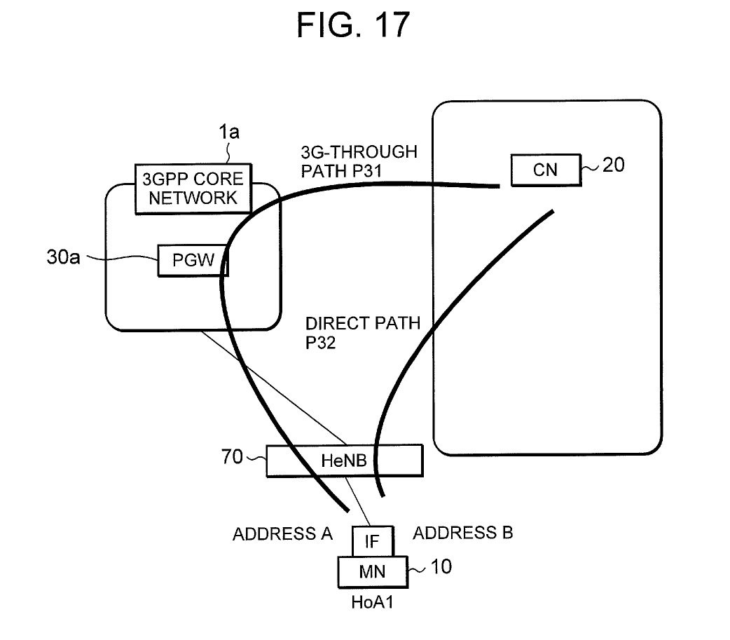

FIG. 17 shows the network configuration when a MN 10 as a UE connects with a HeNB 70 as a home base station to communicate with a CN 20 via a 3G-through path P31 or via a direct path P32. When establishing a connection with the HeNB 70, the MN 10 acquires address A for the 3G-through path P31 and address B for the direct path P32. The MN 10 selects an address to be used as a sender address of a packet transmitted to the CN 20, whereby the MN 10 can use the path P31 or the path P32 appropriately. Assume herein that firstly the MN 10 connects with a macro base station without connecting with the HeNB 70 to communicate with the CN 20 using the 3G-through path P31, and then even after the MN 10 connects with the HeNB 70 using the direct path P32, the MN 10 still wants to maintain a session with the CN 20.

In this case, the MN 10 has to communicate with the CN 20 using the same address before and after switching to the direct path P32. In order to allow the MN 10 to perform communication via the direct path P32 using the address A for the 3G-through path P31, the MN 10 has to notify the CN 20 of address B as a CoA and configure a route optimization path P2 (refer to FIG. 1) for address A with the CN 20. On the other hand, in order to prevent the configuration of the route optimization path P2, i.e., the direct path P32, by a MN 10 that is not permitted, the operator makes the HeNB 70 as proxy to check a HoTI message that the MN 10 transmits. When the HoTI message that the MN 10 transmits includes address B that is not permitted for use to configure a route optimization path, the HeNB 70 blocks such a HoTI message without transferring it. In this case, the MN 10 cannot execute RR and so cannot configure the route optimization path P2, i.e., the direct path P32.

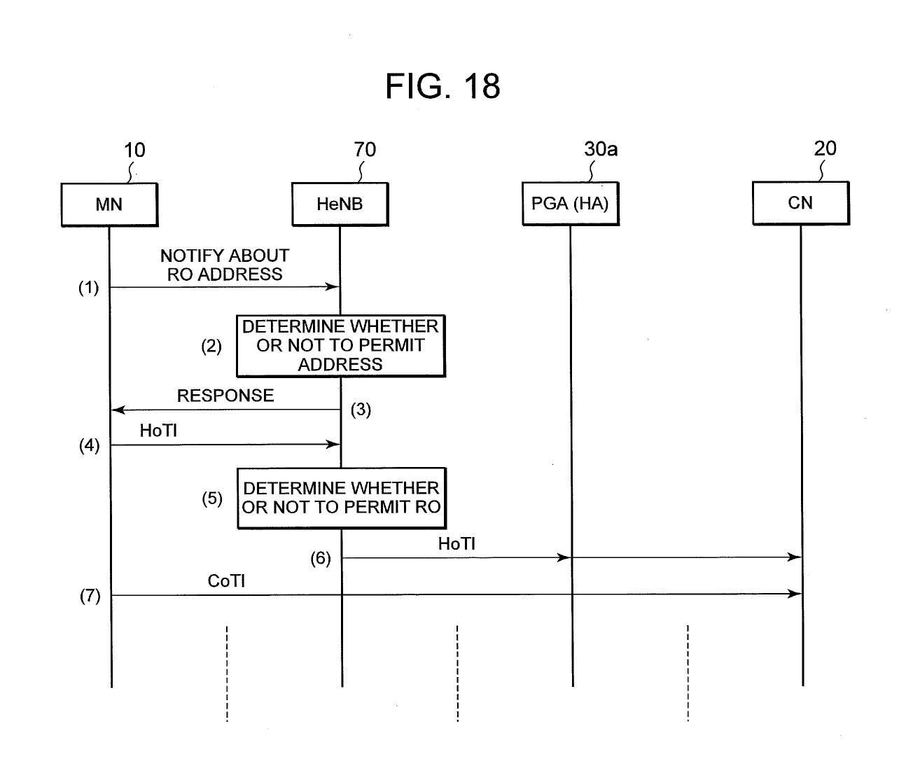

Thus, as shown in FIGS. 18(1) to (7),

(1) In order to configure the route optimization path P2 using address B, the MN 10 notifies the HeNB 70 of address B and requests the HeNB 70 to transfer a HoTI message including address B. As described in Embodiment 3 of the present invention, a method for requesting route optimization using Local-CoA is not limited to the method of notifying about address B. For instance, a flag indicating to request route optimization using Local-CoA may be set in a message transmitted to the HeNB 70, or a notification on payload indicating a request for route optimization may be given. In this case, the HeNB 70 refers to information that the HeNB 70 itself keeps, and finds Local-CoA allocated to the MN 10.

(2) Receiving this request, the HeNB 70 checks whether address B is an address for the direct path P32 that the MN 10 keeps or not. If address B is an address for direct path P32, the HeNB 70 inquires the 3GPP core network 1a about whether the MN 10 is a UE permitted for use in route optimization, and acquires a result thereof. If the MN 10 is a UE permitted for use in route optimization, the HeNB 70 keeps address B as an address for route optimization of the MN 10, and starts checking the same against an address in the HoTI message from the MN 10.

(3) (4) (7) When receiving a response from the HeNB 70 indicating that the use of route optimization using address B is permitted, similarly to Embodiment 1 of the present invention, the MN 10 transmits, to the CN 20, a HoTI message including address B and a CoTI message including CoA comparison request information so as to configure the route optimization path P2 using the direct path P32 with the CN 20.

In typical mobile IP, a HoTI message transmitted from a UE to a HA is encapsulated to be addressed to the HA because such a message is transmitted from the UE connecting with a foreign network. The UE (MN 10) of the present embodiment, however, can transmit the HoTI message using a 3G-through path P31 via the HeNB 70 without encapsulating the same. In this case, the HeNB 70 checks every packet that the UE transmits, and specifies a packet including the HoTI message. As another method, the MN 10 may encapsulate the HoTI message to be addressed to the HeNB 70 for transmission. In this case, since the address of the HeNB 70 is set as a destination of the encapsulated HoTI message, the HeNB 70 simply may check whether a packet is a HoTI message or not only when receiving a packet addressed to the HeNB 70 itself, whereby a load due to proxy reception can be reduced. Herein, the address of the HeNB 70 may be acquired when the MN 10 connects with the HeNB 70.

(5) (6) When the HoTI message reaching the HeNB 70 includes address B, the HeNB 70 transfers such a HoTI message to the CN 20. Similarly to Embodiment 1, the CN 20 compares the address in the HoTI message with the sender address of the CoTI message, and only when they are identical, the CN 20 returns a HoT message and a CoT message to the MN 10 (not shown).

The configuration of the MN 10 in the present embodiment is the same as that of the MN 10 (FIG. 12) described in Embodiment 3. Since the elements of the MN 10 are the same as in FIG. 12 other than a route optimization address selection unit 105a and a route optimization request unit 112, and therefore their description has been omitted. The address selection unit 105a selects address B to use the direct path P32 as an address to be used for route optimization from addresses allocated to the MN 10. The route optimization address selection unit 105a further instructs the route optimization request unit 112 to request route optimization using Local-CoA from the HeNB 70 connected therewith. A non limiting method for requesting is to notify about the selected address B. Prior to notifying the HeNB 70 of a request, the route optimization request unit 112 may request the 3GPP core network 1a (PGW, HSS/AAA) to use address B for route optimization. When a result of such a request leas to permission for use of address B, a message notifying the HeNB 70 about address B may include information indicating that the permission for use of address B has been acquired. As described above in Embodiment 3 of the present invention, the route optimization request unit 112 directly may make a request for the route optimization using Local-CoA from the PGW 30a. In this case, such a request may be notified in a message that is transmitted at the time of generation, changing, or deletion of a PDN connection configured with the PGW 30a, for example.

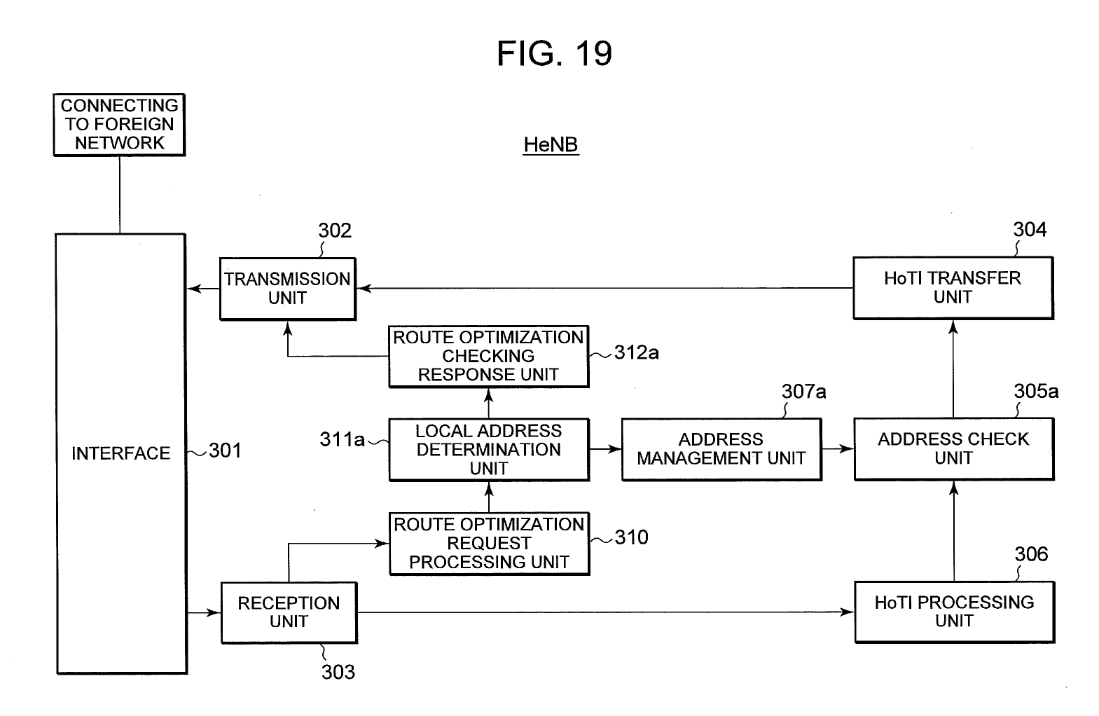

FIG. 19 shows the configuration of the HeNB 70 as a home base station in the present embodiment. The HeNB 70 has the same configuration as that of the HA 30 shown in FIG. 15 other than a local address determination unit 311a and a route optimization checking unit, and therefore the detailed description thereof has been omitted. When receiving a request to use a local address (address B) for route optimization from the MN 10, the local address determination unit 311a checks whether an address corresponding to the direct path P32 is allocated to the MN 10 or not. When address B is allocated, the local address determination unit 311a requests the route optimization checking unit 312a to inquire the PGW 30a of the 3GPP core network 1a about whether the route optimization using address B is permitted or not for the MN 10. When a result of inquiry shows permission, the local address determination unit 311a returns a response to the MN 10, indicating that the use of address B is permitted for the MN 10. Note here that as described above when the MN 10 itself requests the 3GPP core network 1a to use address B, and when the HoTI message includes information indicating that the permission for use of address B has been confirmed, the route optimization address determination unit may omit the inquiry to the 3GPP core network when receiving notification of address B from the MN 10. Receiving an instruction from the local address determination unit 311a, the route optimization checking unit 312a transmits a route optimization checking message to the 3GPP core network 1a (PGW 30a, HSS/AAA) so as to make an inquiry as to whether route optimization using address B can be permitted or not for the MN 10.

The PGW 30a in the present embodiment has the same configuration as that of the HA 30 (FIG. 15) described in Embodiment 3. When receiving an inquiry from the HeNB 70, the route optimization address determination unit 311 determines whether the notified address can be used for route optimization or not, and returns a response. That is, when being requested to use address B for route optimization from the HeNB 70, the PGW 30a of the present embodiment checks whether route optimization using address B can be permitted or not, and when it can be permitted, the PGW 30a instructs the HeNB 70 to check an address included in the HoTI message transmitted from the UE. When the PGW 30a receives a request directly from the UE (MN 10), the route optimization address determination unit 311 determines whether route optimization using Local-CoA can be permitted for the MN 10 or not, and when it can be permitted, the route optimization address determination unit 311 instructs the HeNB 70 to start checking of an address included in the HoTI message and returns a response to the MN 10 indicating that the use of Local-CoA is permitted. In this case, the MN 10 simply may notify the PGW 30a of a request, and does not make a request from the HeNB 70. Thereby, the number of messages that the UE transmits can be decreased, so that consumption of wireless resources can be lowered. When receiving a request directly from the MN 10, the route optimization address determination unit 311 simply can return a response to the MN 10 only, indicating that the notified address can be used for route optimization. In this case, after receiving a response from the PGW 30a, the MN 10 notifies the HeNB 70 of the address and requests the use in route optimization.

According to Embodiment 4 of the present invention, the HeNB 70 connecting with an operator of the 3GPP core network 1a can control depending on the MN 10 whether or not to permit the use of the direct path P32 for route optimization. The permitted MN 10 can generate a route optimization path P2 as shown in FIG. 1 using the direct path P32, and therefore even when handover is performed to the HeNB 70 so as to use the direct path P32, the MN 10 can maintain a session with the CN 20 using HoA1.

Note here that the functions described in Embodiment 4 of the present invention are described as functions to determine whether or not to permit the transferring by the MN 10 of a HoTI message using address B. However, such functions can be used as functions to determine whether or not to permit the use of a direct path by the MN 10. That is, the MN 10 notifies the PGW 30a of address B so as to request communication based on address B using the direct path P32. Such notification of address B may be performed by a HeNB receiving a request from the MN 10. Then, when the use of the direct path P32 is permitted, the PGW 30a instructs the HeNB 70 to permit transferring of a packet using address B, and returns a response to the MN 10, indicating that the use of the direct path is permitted. Receiving the response from the PGW 30a, the MN 10 uses address B to start transmission/reception of a packet. Meanwhile, receiving the instruction from the PGW 30a, the HeNB 70 starts transferring of a packet including address B as a sender and a packet including address B as a destination. As described above, the method described in Embodiment 4 of the present invention is effective to dynamically control whether or not to permit communication using an address or a path whose use is not permitted.

Note that each functional block used in the description of the above-stated embodiments may be typically implemented as a LSI that is an integrated circuit. These blocks may be individually configured as one chip, or one chip may include a part or all of the functional blocks. LSIs may be called an IC (Integrated Circuit), a system LSI, a super LSI, and an ultra LSI depending on the degree of integration. A technique for integrated circuit is not limited to a LSI, but an integrated circuit may be achieved using a dedicated circuit or a general-purpose processor. A FPGA (Field Programmable Gate Array) capable of programming after manufacturing a LSI and a reconfigurable processor capable of reconfiguring connection and setting of a circuit cell inside a LSI may be used. Further, if a technique for integrated circuit that replaces LSIs becomes available by the development of a semiconductor technique or derived techniques, functional blocks may be naturally integrated using such a technique. For instance, biotechnology may be applied thereto.

### INDUSTRIAL APPLICABILITY

The present invention has an advantage of allowing a network operator of a mobile node to securely reject an unfavorable address for use in route optimization, and is applicable to the case, for example, where a mobile node using a 3GPP network accesses a correspondent node directly from a local network that the 3GPP network operator does not want to use for route optimization.

1. A route optimization method for communication between a mobile node and a correspondent node with a direct path not via a mobility management device of the mobile node, comprising the steps of:
a step where the mobile node generates a route optimization request message addressed to the correspondent node and containing a desired address for use with the direct path, and encapsulates the generated route optimization request message addressed to the mobility management device for transmission; and
a step where the mobility management device checks whether the address in the route optimization request message is an address permitted for route optimization or not, and when the address in the route optimization request message is an address permitted, the mobility management device transfers the route optimization request message to the correspondent node, and when the address in the route optimization request message is not an address permitted, the mobility management device discards the route optimization request message.

2. The route optimization method according to claim 1, further comprising a step where the mobility management device checks whether a sender address of an external header in the encapsulated route optimization request message is an address permitted for route optimization or not, and when the sender address is not an address permitted, the mobility management address discards the route optimization request message.

3. The route optimization method according to claim 1, further comprising a step where the mobility management device checks whether a destination address of the route optimization request message is an address permitted for route optimization or not, and when the destination address is not an address permitted, the mobility management address discards the route optimization request message.

4. The route optimization method according to claim 1 further comprising the steps of:
a step where the mobile node transmits a second route optimization request message addressed to the correspondent node, the second route optimization request message being different from the route optimization request message; and
a step where the correspondent node compares a desired address for use with the direct path in the first route optimization request message transferred from the mobility management device with a sender address of the second route optimization request message, and in the case of agreement, the correspondent node permits the direct path, and in the case of disagreement, the correspondent node does not permit the direct path.

5. The route optimization method according to claim 4, further comprising a step where the correspondent node transmits, to the mobile node, a response message containing message authentication code generation information generated from a sender address of the route optimization request message and a desired address for use with the direct path.

6. The route optimization method according to claim 1, further comprising the steps of:
a step where the mobile node notifies beforehand the mobility management device of an address acquired from a local network as a desired address for use with the direct path before transmitting the route optimization request message; and
a step where the mobility management device returns a response to the mobile node as to whether use of the notified address is permitted or not with the direct path, wherein
when use of the notified address is permitted, the mobile node transmits the route optimization request message.

7. A route optimization system for communication between a mobile node and a correspondent node with a direct path not via a mobility management device of the mobile node, wherein
the mobile node comprises a unit that generates a route optimization request message addressed to the correspondent node and containing a desired address for use with the direct path and encapsulates the generated route optimization request message addressed to the mobility management device for transmission, and
the mobility management device comprises a unit that checks whether the address in the route optimization request message is an address permitted for route optimization or not, and when the address in the route optimization request message is an address permitted, transfers the route optimization request message to the correspondent node, and when the address in the route optimization request message is not an address permitted, discards the route optimization request message.

8. The route optimization system according to claim 7, wherein the mobility management device further comprises a unit that checks whether a sender address of an external header in the encapsulated route optimization request message is an address permitted for route optimization or not, and when the sender address is not an address permitted, discards the route optimization request message.

9. The route optimization system according to claim 7, wherein the mobility management device further comprises a unit that checks whether a destination address of the route optimization request message is an address permitted for route optimization or not, and when the destination address is not an address permitted, discards the route optimization request message.

10. The route optimization system according to claim 7, wherein
the mobile node further comprises a unit that transmits a second route optimization request message addressed to the correspondent node, the second route optimization request message being different from the route optimization request message, and
the correspondent node further comprises a unit that compares a desired address for use with the direct path in the first route optimization request message transferred from the mobility management device with a sender address of the second route optimization request message, and in the case of agreement, permits the direct path, and in the case of disagreement, does not permit the direct path.

11. The route optimization system according to claim 10, wherein the correspondent node further comprises a unit that transmits, to the mobile node, a response message containing message authentication code generation information generated from a sender address of the route optimization request message and a desired address for use with the direct path.

12. The route optimization system according to claim 7, wherein
the mobile node further comprises a unit that notifies beforehand the mobility management device of an address acquired from a local network as a desired address for use with the direct path before transmitting the route optimization request message, and
the mobility management device further comprises a unit that returns a response to the mobile node as to whether use of the notified address is permitted or not with the direct path, wherein
when use of the notified address is permitted, the mobile node transmits the route optimization request message.

13. A mobile node in a route optimization system for communication between the mobile node and a correspondent node with a direct path not via a mobility management device of the mobile node, comprising
a unit that generates a route optimization request message addressed to the correspondent node and containing a desired address for use with the direct path and encapsulates the generated route optimization request message addressed to the mobility management device for transmission.

14. The mobile node according to claim 13, further comprising a unit that notifies beforehand the mobility management device of an address acquired from a local network as a desired address for use with the direct path before transmitting the route optimization request message,
wherein
when use of the notified address is permitted, the mobile node transmits the route optimization request message.

15. A mobility management device in a route optimization system for communication between a mobile node and a correspondent node with a direct path not via the mobility management device of the mobile node, comprising:
a unit that receives a message obtained by encapsulating a route optimization request message addressed to the mobility management device, the route optimization request message being addressed to the correspondent node and containing a desired address for use with the direct path; and
a unit that checks whether the address in the route optimization request message is an address permitted for route optimization or not, and when the address in the route optimization request message is an address permitted, transfers the route optimization request message to the correspondent node, and when the address in the route optimization request message is not an address permitted, discards the route optimization request message.

16. The mobility management device according to claim 15, further comprising a unit that checks whether a sender address of an external header in the encapsulated route optimization request message is an address permitted for route optimization or not, and when the sender address is not an address permitted, discards the route optimization request message.

17. The mobility management device according to claim 15, further comprising a step that checks whether a destination address of the route optimization request message is an address permitted for route optimization or not, and when the destination address is not an address permitted, discards the route optimization request message.

18. The mobility management device according to claim 15, further comprising a unit that, when the mobile node notifies beforehand the mobility management device of an address acquired from a local network as a desired address for use with the direct path before transmitting the route optimization request message, returns a response to the mobile node as to whether use of the notified address is permitted or not with the direct path.

19. A correspondent node in a route optimization system for communication between a mobile node and the correspondent node with a direct path not via a mobility management device of the mobile node, comprising:
a unit that receives a route optimization request message addressed to the correspondent node and containing a desired address for use with the direct path and a second route optimization request message transmitted from the mobile node addressed to the correspondent node, the second route optimization request message being different from the route optimization request message; and
a unit that compares a desired address for use with the direct path in the route optimization request message with a sender address of the second route optimization request message, and in the case of agreement, permits the direct path, and in the case of disagreement, does not permit the direct path.

20. The correspondent node according to claim 19, further comprising a unit that transmits, to the mobile node, a response message containing message authentication code generation information generated from a sender address of the route optimization request message and a desired address for use with the direct path.

21-24. (canceled)
